(19) United States
(12) Patent Application Publication
(10) Pub. No.: US 2020/0263618 A1
(43) Pub. Date: Aug. 20, 2020

(54) PM AMOUNT ESTIMATION DEVICE, PM AMOUNT ESTIMATION SYSTEM, PM AMOUNT ESTIMATING METHOD, DATA ANALYSIS DEVICE, CONTROL DEVICE FOR INTERNAL COMBUSTION ENGINE, AND RECEIVER

(71) Applicant: TOYOTA JIDOSHA KABUSHIKI KAISHA, Toyota-shi (JP)

(72) Inventors: Harufumi Muto, Miyoshi-shi (JP); Atsushi Nagai, Toyota-shi (JP); Kohei Mori, Toyota-shi (JP); Yosuke Hashimoto, Nagakute-shi (JP)

(73) Assignee: TOYOTA JIDOSHA KABUSHIKI KAISHA, Toyota-shi (JP)

(21) Appl. No.: 16/780,995

(22) Filed: Feb. 4, 2020

(30) Foreign Application Priority Data
Feb. 20, 2019 (JP) 2019-028476

(51) Int. Cl. F02D 41/02; F01N 3/021; F01N 11/00; F02D 41/32; F02P 5/04; F02P 5/14; F01N 9/00

(52) U.S. Cl. CPC F02D 41/029; F01N 3/021; F01N 11/00; F02D 41/32; F02P 5/045; F02D 2200/0812; F01N 9/002; F01N 2550/04; F02D 2200/0414; F02D 2200/023; F02P 5/14

(57) ABSTRACT

A PM amount estimation device is applied to a filter that collects PM in the exhaust gas discharged to an exhaust passage of an internal combustion engine. A storage device stores mapping data which is data defining a mapping that outputs the PM amount collected by the filter. The mapping has at least one of an intake air temperature variable and a wall surface variable, and a flow rate variable as inputs. The intake air temperature variable relates to the temperature of air drawn into the engine. The wall surface variable relates to a cylinder wall surface temperature of the engine. The flow rate variable indicates the flow rate of the fluid entering the filter. The execution device calculates the PM amount based on the output of the mapping having the acquired data as an input.

### BACKGROUND OF THE INVENTION

### 1. Field

The following description relates to a PM amount estimation device, a PM amount estimation system, a data analysis device, a control device for an internal combustion engine, and a receiver.

### 2. Description of Related Art

Japanese Laid-Open Patent Publication No. 2006-316726 describes an example of a device that estimates the PM amount based on the rotation speed and load of an internal combustion engine. The PM amount is the amount of particulate matter collected by a filter in an exhaust passage.

The change amount of the PM amount is not determined by only the rotation speed and the load and is affected by on various variables. Thus, it is difficult to accurately calculate the PM amount when using only the rotation speed NE and the load.

### SUMMARY OF THE INVENTION

Hereinafter, examples of the present disclosure will be described.

### Example 1

A PM amount estimation device including a storage device and an execution device. The PM amount estimation device is applied to a filter that collects PM from exhaust gas discharged to an exhaust passage of an internal combustion engine. The storage device is configured to store mapping data that is data defining a mapping that outputs a PM amount collected by the filter. The mapping has a flow rate variable and at least one of an intake air temperature variable and a wall surface variable as an input. The intake air temperature variable is a variable related to a temperature of air drawn into the internal combustion engine. The wall surface variable is a variable related to a cylinder wall surface temperature of the internal combustion engine. The flow rate variable is a variable indicating a flow rate of a fluid entering the filter. The execution device is configured to execute an acquiring process for acquiring the flow rate variable and at least one of the intake air temperature variable and the wall surface variable, a PM amount calculation process for calculating the PM amount based on the output of the mapping having the data acquired by the acquiring process as the input, and an operation process for operating predetermined hardware in accordance with the PM amount.

In the configuration described above, the PM amount is calculated based on at least one of the intake air temperature variable and the wall surface variable. Here, when the intake air temperature variable is different, the temperature of the air-fuel mixture in the compression process is different, the combustion state is changed, and the PM emission amount is changed. Therefore, if the PM amount is calculated based on the intake air temperature variable, the PM amount can be calculated with higher accuracy than, for example, when the PM amount is calculated regardless of the intake air temperature variable. Furthermore, when the wall surface temperature is low, the fuel collects on the wall surface and PM is generated more easily than when the wall surface temperature is high. Therefore, if the PM amount is calculated based on the wall surface temperature variable, the PM amount can be calculated with higher accuracy than, for example, when the PM amount is calculated regardless of the wall surface temperature variable.

### Example 2

The PM amount estimation device according to example 2 in which the input of the mapping includes an increase variable. The increase variable is a variable indicating an amount at which a fuel amount in an air-fuel mixture subject to combustion in a combustion chamber of the internal combustion engine exceeds an amount for having an air-fuel ratio of the air-fuel mixture be the stoichiometric air-fuel ratio. The acquiring process includes a process for acquiring the increase variable. The PM amount calculation process is a process for calculating the PM amount based on the output of the mapping in which the increase variable is further included in the input to the mapping.

In the configuration described above, the PM amount is calculated based on the increase variable. Accordingly, the PM amount can be calculated based on the fact that the PM emission amount increases when the fuel amount in the air-fuel mixture exceeds the fuel amount corresponding to the stoichiometric air-fuel ratio. As a result, the PM amount can be calculated with high accuracy.

### Example 3

The PM amount estimation device according to the first example or the second example in which the acquiring process includes a process for acquiring an action point variable, which is a variable defining an action point of the internal combustion engine, as the flow rate variable.

In the configuration described above, the action point variable is used as the flow rate variable in view of the fact that the flow rate is determined in correspondence with the action point of the internal combustion engine. Furthermore, the operation amounts of the various operation units of the internal combustion engine tend to be set according to the action point. Therefore, in the configuration described above, the PM amount can be calculated taking into consideration the difference in the PM amount due to the difference in various operation amounts by including the action point variable in the input of the mapping.

### Example 4

The PM amount estimation device according to any one of examples 1 to 3 in which the input of the mapping includes an ignition variable that is a variable related to an ignition timing. The acquiring process includes a process for acquiring the ignition variable. The PM amount calculation process is a process for calculating the PM amount based on the output of the mapping in which the ignition variable is further included in the input to the mapping.

In the configuration described above, the PM amount is calculated based on the ignition variable. Thus, the PM amount can be calculated while recognizing that combustion becomes unstable when the ignition timing is retarded and greatly affects the PM emission. As a result, for example, the PM amount can be calculated with higher accuracy compared to, for example, when the PM amount is calculated regardless of the ignition variable.

### Example 5

The PM amount estimation device according to any one of examples 1 to 4 in which the internal combustion engine includes a port injection valve. The input to the mapping includes a collected amount variable that is a variable indicating a fuel amount collected in an intake system of the internal combustion engine. The acquiring process includes a process for acquiring the collected amount variable. The PM amount calculation process is a process for calculating the PM amount based on the output of the mapping in which the collected amount variable is further included in the input to the mapping.

When the fuel amount collected in the intake system is large, the PM emission amount tends to be larger than when the fuel amount is small. Therefore, in the configuration described above, the PM amount is calculated based on the collected amount variable. Thus, the PM amount can be calculated based on a variable having a strong positive correlation with the PM emission amount. As a result, the PM amount can be calculated with high accuracy.

### Example 6

The PM amount estimation device according to any one of examples 1 to 5 in which the input of the mapping includes an air-fuel ratio detection variable that is a variable related to a detection value of an air-fuel ratio sensor located at an upstream side of the filter. The acquiring process includes a process for acquiring the air-fuel ratio detection variable. The PM amount calculation process is a process for calculating the PM amount based on the output of the mapping in which the air-fuel ratio detection variable is further included in the input to the mapping.

The oxygen amount and the unburned fuel amount in the exhaust gas entering the filter are parameters that determine the oxidation amount of the PM amount collected by the filter. Therefore, in the above configuration, the PM amount is calculated based on the air-fuel ratio detection variable which is a variable corresponding to a sufficient ratio of the actual fuel amount to the fuel amount that reacts with the oxygen entering the filter. Accordingly, the PM amount can be calculated based on a parameter having a strong correlation with the PM oxidation amount and, consequently, the PM amount can be calculated with high accuracy.

### Example 7

The PM amount estimation device according to any one of examples 1 to 6 in which the storage device stores plural types of the mapping data. The PM amount calculation process includes a selecting process for selecting the mapping data used to calculate the PM amount from the plural types of mapping data.

In any situation, when forming a mapping that can output the PM amount with high accuracy, the structure of the mapping tends to be easily complicated. Therefore, in the above configuration, plural types of mapping data are provided. This makes it possible to select a mapping appropriate for the situation. In that case, for example, the structure of each of a plurality of types of mappings can be easily simplified as compared with when all situations are handled with a single mapping.

### Example 8

The PM amount estimation device according to example 7 in which the mapping data includes high-temperature mapping data and low-temperature mapping data. The high-temperature mapping data is data defining the mapping when the temperature of the internal combustion engine is high, and the low-temperature mapping data is data defining the mapping when the temperature of the internal combustion engine is lower than the temperature of the internal combustion engine subject to the high-temperature mapping data. The selecting process includes a process for selecting one of the high-temperature mapping data and the low-temperature mapping data as the mapping data used to calculate the PM amount in accordance with the temperature of the internal combustion engine.

The PM emission amount differs greatly depending on whether the temperature of the internal combustion engine is high or low. Thus, for example, when calculating the PM amount with a single mapping regardless of the temperature of the internal combustion engine, the same mapping is used even for events of which the PM emission differs greatly. This causes the structure of the mapping to be complicated. In the above configuration, the structure of the mapping data can be easily simplified with the high-temperature mapping data and the low-temperature mapping data that are different.

### Example 9

The PM amount estimation device according to any one of examples 1 to 8 in which the input of the mapping includes the temperature of the filter. The acquiring process includes a process for acquiring the temperature of the filter. The mapping includes an emission amount mapping that outputs an emission amount of PM from the combustion chamber of the internal combustion engine to the exhaust passage having a variable other than the temperature of the filter among the variables acquired by at least the acquiring process as an input, an oxidation amount mapping that outputs an oxidation amount of PM collected by the filter having at least the PM amount before an update and the temperature of the filter as an input, and an update mapping that outputs the PM amount based on the PM amount before the update, the emission amount, and the oxidation amount. The PM amount calculation process includes an emission amount calculation process for calculating the emission amount by inputting a variable other than the temperature of the filter among the variables acquired by at least the acquiring process to the emission amount mapping, an oxidation amount calculation process for calculating the oxidation amount by inputting at least the PM amount before the update and the temperature of the filter to the oxidation amount mapping, and an update process for updating the PM amount by inputting the PM amount before the update, the emission amount, and the oxidation amount to the update mapping.

The amount of PM collected by the filter is determined in correspondence with the PM discharged to the exhaust passage and the PM oxidized by the filter. The PM emission and the PM oxidation are different events. Thus, for example, when calculating the PM amount with a single mapping, the single mapping is used for different events thereby causing the structure of the mapping to be complicated. Therefore, in the above configuration, the mapping that outputs the PM emission amount differs from the mapping that outputs the PM oxidation amount. This simplifies each mapping.

### Example 10

The PM amount estimation device according to example 9 in which the data defining the emission amount mapping includes high-temperature emission amount mapping data and low-temperature emission amount mapping data. The high-temperature emission amount mapping data is data defining the emission amount mapping when the temperature of the internal combustion engine is high, and the low-temperature emission amount mapping data is data defining the emission amount mapping when the temperature of the internal combustion engine is lower than the temperature of the internal combustion engine subject to the high-temperature emission amount mapping data. The emission amount calculation process includes a selecting process for selecting data used to calculate the emission amount from the high-temperature emission amount mapping data and the low-temperature emission amount mapping data in accordance with the temperature of the internal combustion engine.

The PM emission amount differs greatly depending on whether the temperature of the internal combustion engine is high or low. Thus, for example, when calculating the PM emission amount with a single mapping regardless of the temperature of the internal combustion engine, the structure of the mapping is complicated. In the above configuration, the high-temperature emission amount mapping data and the low-temperature emission amount mapping data are different. Thus, the structure of the mapping data is simplified.

### Example 11

The PM amount estimation device according to any one of examples 1 to 10 in which a raising operation unit is an operation unit of the internal combustion engine and used to raise the temperature of the filter. The operation process includes a regeneration process for combusting the PM collected by the filter by operating the raising operation unit when the PM amount is greater than or equal to a specified amount.

In the above configuration, the regeneration process is performed based on the PM amount calculated using at least one of the intake air temperature variable and the wall surface temperature variable. As a result, the regeneration process can be performed based on the highly accurate PM amount. Consequently, the regeneration process can be performed at an appropriate timing.

### Example 12

The PM amount estimation device according to any one of examples 1 to 11 in which the operation process includes a determination process for determining whether the filter has an anomaly based on a detection value of a pressure difference of an upstream side and downstream side of the filter, the flow rate of the fluid entering the filter, and the PM amount. A notification process for operating a notification device to issue a notification indicating that there is anomaly in the filter when determined that there is an anomaly in the determination process.

The pressure difference between the upstream side and the downstream side of the filter can be recognized from the flow rate of the fluid and the PM amount. Thus, when the pressure difference recognized from the flow rate of the fluid and the PM amount is greatly deviated from the detection value, the filter is defective. In the above configuration, therefore, anomaly of the filter is determined based on the flow rate of the fluid, the PM amount, and the detection value of the pressure difference. If there is an anomaly, the notification process issues a notification.

### Example 13

A PM amount estimation system including the execution device and the storage device recited in any one of example 1 to 12 in which the execution device includes a first execution device and a second execution device. The first execution device is installed in a vehicle and configured to execute the acquiring process, a vehicle-side transmitting process for transmitting the data acquired by the acquiring process to outside the vehicle, a vehicle-side receiving process for receiving a signal based on the PM amount calculated by the PM amount calculation process, and the operation process. The second execution device is located outside the vehicle and configured to execute an external-side receiving process for receiving the data transmitted by the vehicle-side transmitting process, the PM amount calculation process, and an external-side transmitting process for transmitting a signal based on the PM amount calculated by the PM amount calculation process to the vehicle.

In the above configuration, the calculation load on the in-vehicle device is reduced by executing the PM amount calculation process outside the vehicle.

### Example 14

A data analysis device includes the second execution device and the storage device recited in example 13.

### Example 15

A control device for an internal combustion engine includes the first execution device recited in example 13.

### Example 16

A receiver that is hardware configuring part of the PM amount estimation system according to example 13 in which the receiver is configured to execute the vehicle-side receiving process.

### Example 17

The processes recited in any one of examples 1 to 16 are executed and embodied as a PM amount estimating method.

### Example 18

The processes recited in any one of examples 1 to 17 are embodied as a non-transitory computer-readable recording medium storing a program executed by a processor.

Other features and aspects will be apparent from the following detailed description, the drawings, and the claims.

### BRIEF DESCRIPTION OF THE DRAWINGS

FIG. 1 is a diagram showing the configuration of a control device and a drive system of a vehicle according to a first embodiment;

FIG. 2 is a block diagram showing part of a process executed by the control device according to the first embodiment;

FIG. 3 is a flowchart showing a PM amount estimation process according to the first embodiment;

FIG. 4 is a flowchart showing a handling process to the deposited PM according to the first embodiment;

FIG. 5 is a diagram showing a system for generating mapping data according to the first embodiment;

FIG. 6 is a flowchart showing a mapping data learning process according to the first embodiment;

FIG. 7 is a flowchart showing the mapping data learning process according to the first embodiment;

FIG. 8 is a flowchart showing a PM amount estimation process according to a second embodiment;

FIG. 9 is a flowchart showing a process executed by a control device according to a third embodiment;

FIG. 10 is a flowchart showing a PM amount estimation process according to a fourth embodiment;

FIG. 11 is a flowchart showing a selecting process according to a fifth embodiment;

FIG. 12 is a diagram showing the configuration of a PM amount estimation system according to a sixth embodiment; and

FIG. 13 is a flowchart including section (a) and section (b) and showing procedures of a process executed by the PM amount estimation system of FIG. 12.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

### First Embodiment

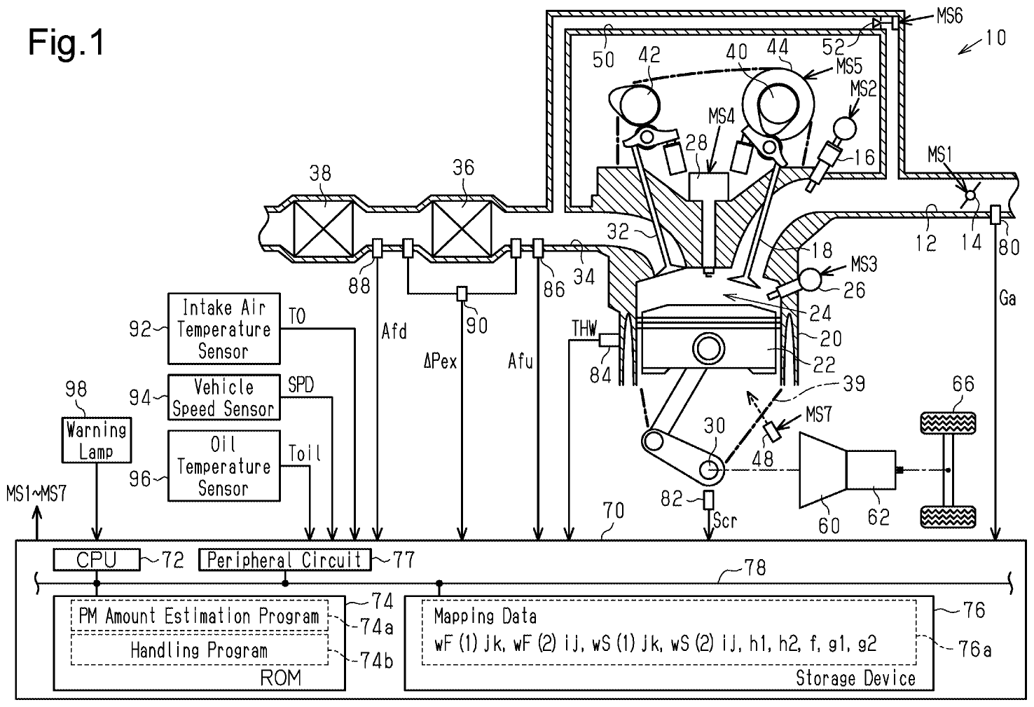

Hereinafter, a first embodiment of a PM amount estimation device will be described with reference to FIGS. 1 to 7.

An internal combustion engine 10 shown in FIG. 1 is mounted on a vehicle. A throttle valve 14 and a port injection valve 16 are provided in order from an upstream side on an intake passage 12 of the internal combustion engine 10. Air drawn into the intake passage 12 and fuel injected from the port injection valve 16 flow into a combustion chamber 24 defined by a cylinder 20 and a piston 22 when an intake valve 18 opens. An in-cylinder injection valve 26 injects fuel into the combustion chamber 24. In the combustion chamber 24, the air-fuel mixture is combusted by the spark discharge of an ignition device 28. The combustion energy generated by the combustion is converted to rotational energy of a crankshaft 30 by the piston 22. The combusted air-fuel mixture is discharged to an exhaust passage 34 as exhaust gas when an exhaust valve 32 opens. In order from the upstream side, the exhaust passage 34 includes a GPF 36 and a catalyst 38. The GPF is a filter that collects particulate matter, or PM, and carries a three-way catalyst having an oxygen storage capacity. The catalyst 38 is a three-way catalyst having an oxygen storage capacity.

The rotational power of a crankshaft 30 is transmitted to an intake side camshaft 40 and an exhaust side camshaft 42 by a timing chain 39. In the present embodiment, the power of the timing chain 39 is transmitted to the intake side camshaft 40 by an intake side valve timing variable device 44. The intake side valve timing variable device 44 is an actuator that adjusts the valve opening timing of the intake valve 18 by adjusting the rotational phase difference between the crankshaft 30 and the intake side camshaft 40.

An oil jet 48 controls the ejection and stopping of the lubricating oil toward a surface of the piston 22 at a side opposite to a top face side, which is the surface corresponding to the combustion chamber 24.

An EGR passage 50 that connects the exhaust passage 34 and the intake passage 12 to each other is connected to the upstream of the GPF 36 in the exhaust passage 34. The EGR passage 50 is provided with an EGR valve 52 for adjusting the flow path cross-sectional area. Furthermore, drive wheels 66 are mechanically connected to the crankshaft 30 by a torque converter 60 and a transmission 62.

A control device 70 controls the internal combustion engine 10 and operates operation units such as the throttle valve 14, the port injection valve 16, the in-cylinder injection valve 26, the ignition device 28, the intake side valve timing variable device 44, the EGR valve 52, the oil jet 48, and the like to control the torque, exhaust component ratio, and the like, which are control amounts, of the internal combustion engine 10. FIG. 1 shows operation signals MS1 to MS7 of each of the throttle valve 14, the port injection valve 16, the in-cylinder injection valve 26, the ignition device 28, the intake side valve timing variable device 44, the EGR valve 52, and the oil jet 48.

When controlling the control amount, the control device 70 refers to an intake air amount Ga detected by an air flow meter 80, an output signal Scr of a crank angle sensor 82, and a coolant temperature THW, which is the temperature of the coolant of the internal combustion engine 10 detected by a coolant temperature sensor 84. Furthermore, the control device 70 refers to an upstream detection value Afu, which is a detection value of an upstream air-fuel ratio sensor 86 located at an upstream side of the GPF 36, and a downstream detection value Afd, which is a detection value of a downstream air-fuel ratio sensor 88 provided between the GPF 36 and the catalyst 38. In addition, the control device 70 refers to a pressure difference ΔPex of the pressure of exhaust gas on the upstream side and the pressure of exhaust gas on the downstream side of the GPF 36 detected by a pressure difference sensor 90, an intake air temperature TO detected by an intake air temperature sensor 92, a vehicle speed SPD detected by a vehicle speed sensor 94, and an oil temperature Toil, which is the temperature of the lubricating oil detected by an oil temperature sensor 96.

The control device 70 includes a CPU 72, a ROM 74, a storage device 76, which is an electrically rewritable non-volatile memory, and a peripheral circuit 77 that communicate with one another through a local network 78. The peripheral circuit 77 includes a circuit that generates a clock signal defining an internal operation, a power supply circuit, a reset circuit, and the like.

The control device 70 executes control of the control amount with the CPU 72 by executing a program stored in the ROM 74.

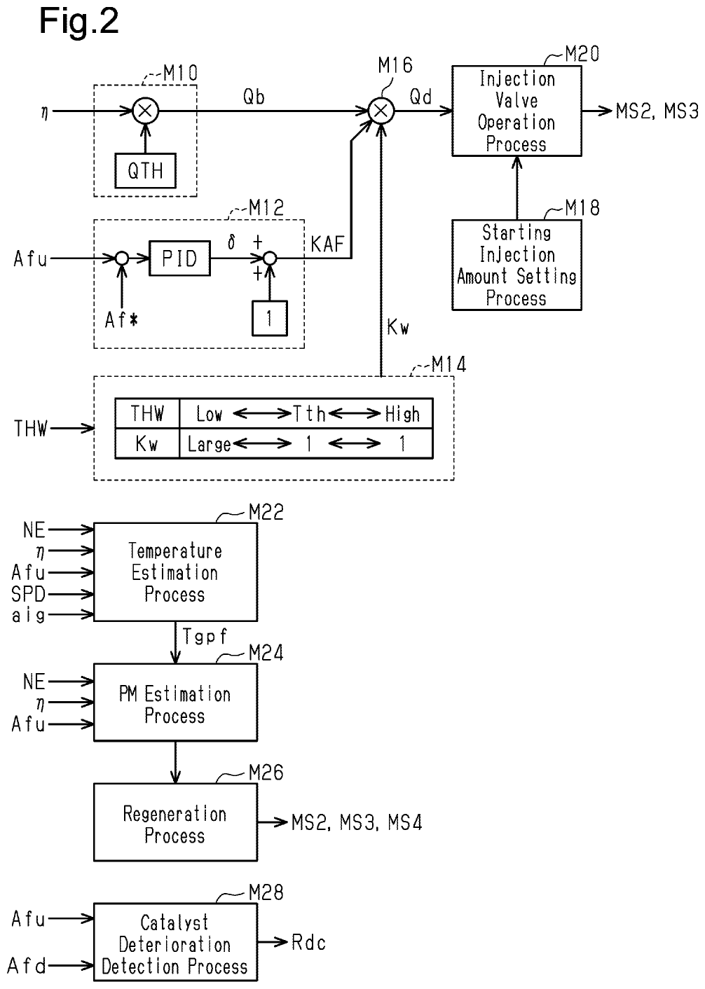

FIG. 2 shows part of the process implemented by the CPU 72 executing a program stored in the ROM 74.

A base injection amount calculation process M10 is a process for calculating a base injection amount Qb based on the filling efficiency 11. The base injection amount Qb is a base value of a fuel amount for making the air-fuel ratio of the air-fuel mixture in the combustion chamber 24 to the target air-fuel ratio. Specifically, when the filling efficiency n is expressed as a percentage, for example, the base injection amount calculation process M10 may be a process for calculating the base injection amount Qb by multiplying the fuel amount QTH per 1% of the filling efficiency η by the filling efficiency η so that the air-fuel ratio becomes equal to the target air-fuel ratio. The base injection amount Qb is a fuel amount calculated to control the air-fuel ratio to the target air-fuel ratio based on the amount of air filled in the combustion chamber 24. The target air-fuel ratio may be, for example, the stoichiometric air-fuel ratio. The filling efficiency 11 is a parameter that determines the amount of air the combustion chamber 24 is filled with and is calculated by the CPU 72 based on the rotation speed NE and the intake air amount Ga. The rotation speed NE is calculated by the CPU 72 based on the output signal Scr of the crank angle sensor 82.

A feedback process M12 is a process for calculating and outputting a feedback correction coefficient KAF obtained by adding “1” to a correction ratio δ of the base injection amount Qb. The correction ratio δ of the base injection amount Qb is a feedback operation amount which is an operation amount for feedback controlling the upstream detection value Afu to a target value Af*. Specifically, the feedback process M12 sets a sum of each output value of a proportional element and a differentiation element, having the difference between the upstream detection value Afu and the target value Af* as the input, and an output value of an integral element that holds and outputs an integrated value of a value corresponding to the difference as a correction ratio δ.

A low temperature correcting process M14 is a process for calculating a low temperature increase coefficient Kw to a value larger than “1” in order to increase the base injection amount Qb when the coolant temperature THW is lower than a predetermined temperature Tth (e.g., 60° C.). Specifically, the low temperature increase coefficient Kw is calculated to a larger value when the coolant temperature THW is low than when the coolant temperature THW is high. When the coolant temperature THW is higher than or equal to the predetermined temperature Tth, the low temperature increase coefficient Kw is set to “1”, and the correction amount of the base injection amount Qb is set to zero by the low temperature increase coefficient Kw.

A required injection amount calculation process M16 calculates a required injection amount Qd by multiplying the base injection amount Qb by the feedback correction coefficient KAF and the low temperature increase coefficient Kw.

A starting injection amount setting process M18 setting the injection amount for when the internal combustion engine 10 is started. The starting injection amount setting process M18 is a process for setting the injection amount to inject a greater amount of fuel than the amount of fuel necessary for the air-fuel ratio of the air-fuel mixture subject to combustion in the combustion chamber 24 to be equal to the stoichiometric air-fuel ratio, particularly from the viewpoint of reducing misfire and the like when the internal combustion engine 10 is started.

An injection valve operation process M20 is a process for outputting an operation signal MS2 to the port injection valve 16 to operate the port injection valve 16 or outputting an operation signal MS3 to the in-cylinder injection valve 26 to operate the in-cylinder injection valve 26. Specifically, the injection valve operation process M20 is a process for setting the injection ratio of the port injection valve 16 with respect to the required injection amount Qd as the injection sharing ratio Kp, and operating the port injection valve 16 and the in-cylinder injection valve 26 according to the injection sharing ratio Kp after starting the internal combustion engine 10. Furthermore, the injection valve operation process M20 is a process for operating the port injection valve 16 to cause the port injection valve 16 to inject the fuel of the injection amount set by the starting injection amount setting process M18 when starting the internal combustion engine 10.

A temperature estimation process M22 is a process for calculating a filter temperature Tgpf which is an estimated value of the temperature of the GPF 36 based on the rotation speed NE, the filling efficiency the upstream detection value Afu, the vehicle speed SPD, and the ignition timing aig. Specifically, the temperature estimation process M22 includes a process in which the CPU 72 performs a map calculation of the base value based on map data having the rotation speed NE and the filling efficiency η as input variables and the base value of the temperature of the GPF 36 as an output variable. Furthermore, the temperature estimation process M22 includes a process for correcting the base value so that the filter temperature Tgpf becomes higher when the upstream detection value Afu is rich than when it is lean. This is implemented by the CPU 72 map calculating a first correction amount based on map data having the upstream detection value Afu as an input variable and the first correction amount for correcting the base value as an output variable. The temperature estimation process M22 includes a process of correcting the base value so that the filter temperature Tgpf becomes lower when the vehicle speed SPD is high than when it is low. This is implemented by the CPU 72 map calculating a second correction amount based on map data having the vehicle speed SPD as an input variable and the second correction amount for correcting the base value as an output variable. Moreover, the temperature estimation process M22 includes a process for correcting the base value so that the filter temperature becomes higher when the ignition timing aig is on the retard side than when it is on the advance side. This is implemented by the CPU 72 map calculating a third correction amount based on map data having the ignition timing aig as an input variable and the third correction amount for correcting the base value as an output variable.

The map data is set data of a discrete value of the input variable and a value of the output variable corresponding to each value of the input variable. The map calculation may be, for example, a process of having the value of the output variable of the corresponding map data as a calculation result when the value of the input variable matches one of the values of the input variables of the map data, and having a value obtained by interpolation of the values of a plurality of output variables included in the map data as a calculation result when the value of the input variable does not match any of the values of the input variables of the map data.

A PM estimation process M24 is a process for estimating the PM amount which is the amount of particulate matter collected by the GPF 36 based on the filter temperature Tgpf and the like. This will be described in detail later.

A regeneration process M26 is a process for operating the ignition device 28 and the like to oxidize and remove the PM collected by the GPF 36 based on the PM amount.

A catalyst deterioration detection process M28 is a process for detecting the deterioration degree of the three-way catalyst carried on the GPF 36 as the deterioration rate Rdc. Specifically, the catalyst deterioration detection process M28 is a process for calculating the maximum value of the oxygen storage amount of the three-way catalyst and calculating the deterioration rate Rdc as the degree to which the maximum value falls below the reference value. Here, to calculate the oxygen storage amount, the downstream detection value Afd first becomes richer than the stoichiometric point indicating the stoichiometric air-fuel ratio so that the oxygen storage amount of the three-way catalyst becomes zero. Thereafter, the air-fuel ratio of the air-fuel mixture subject to combustion is made lean, and the oxygen storage amount is calculated based on the integrated value of the oxygen flow rate to the GPF 36 until the downstream detection value Afd becomes leaner than the stoichiometric point.

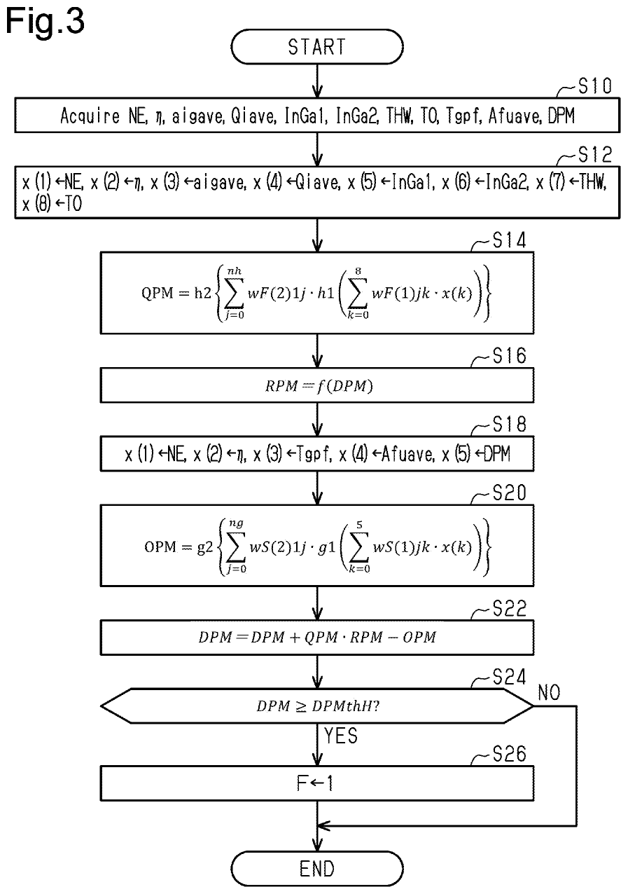

FIG. 3 shows the procedure of the PM estimation process M24. The process shown in FIG. 3 is implemented by the CPU 72 repeatedly executing the PM amount estimation program 74a stored in the ROM 74 shown in FIG. 1, for example, in predetermined cycles. Hereinafter, the step number of each process is represented by “S” followed by a numeral.

In the series of processes shown in FIG. 3, the CPU 72 acquires the rotation speed NE, the filling efficiency η, the ignition timing average value aigave, the increase amount average value Qiave, the starting integrated air amount InGa1, the post-starting integrated air amount InGa2, the coolant temperature THW, the intake air temperature TO, the filter temperature Tgpf, the upstream average value Afuave, and the PM deposition amount DPM, which is the PM amount (S10). The PM deposition amount DPM acquired here is the previous value calculated in the previous cycle of the series of processes shown in FIG. 3. The initial value of the PM deposition amount DPM when the process of FIG. 3 has never been executed is zero. The ignition timing average value aigave, the increase amount average value Qiave, and the upstream average value Afuave are respectively the average value of the ignition timing aig, the average value of the increase amount Qi, and the average value of the upstream detection value Afu in the processing cycle of S10. For example, in the processing cycle of S10, the CPU 72 samples the upstream detection value Afu a number of times, calculates the average value thereof, and sets it as the upstream average value Afuave. Furthermore, the increase amount Qi is an average value of the increase amounts Qi of the required injection amount Qd with respect to the base injection amount Qb, and may take a negative value. The increase amount Qi indicates the sufficient fuel amount necessary for the air-fuel ratio of the air-fuel mixture to be equal to the stoichiometric air-fuel ratio.

Furthermore, the starting integrated air amount InGa1 is an integrated value of the air amount drawn in when starting the internal combustion engine 10. The post-starting integrated air amount InGa2 is an integrated value of the intake air amount Ga after starting the internal combustion engine 10.

Next, the CPU 72 sets some of the variables acquired in the process of S10 as input variables of the mapping defined by the mapping data 76a stored in the storage device 76 shown in FIG. 1 and outputting a PM emission amount QPM which is the emission amount of the PM to the exhaust passage 34 (S12). That is, the CPU 72 substitutes the rotation speed NE to the input variable x(1), substitutes the filling efficiency η to the input variable x(2), substitutes the ignition timing average value aigave to the input variable x(3), substitutes the increase amount average value Qiave to the input variable x(4), substitutes the starting integrated air amount InGa1 to the input variable x(5), and substitutes the post-starting integrated air amount InGa2 to the input variable x(6). Furthermore, the CPU 72 substitutes the coolant temperature THW to the input variable x(7), and substitutes the intake air temperature TO to the input variable x(8).

Next, the CPU 72 calculates the PM emission amount QPM by inputting the input variables x(1) to x(8) into the mapping that outputs the PM emission amount QPM (S14). The mapping according to the present embodiment is configured by a neural network in which the intermediate layer is one layer, the activation function h1 of the intermediate layer is hyperbolic tangent, and the activation function h2 of the output layer is ReLU. ReLU is a function that outputs the one of the input and zero that is not smaller. In other words, when the input is not zero, ReLU is a function that outputs the larger one of the input and zero, and when the input is zero, ReLU is a function that outputs zero.

Here, the value of each node in the intermediate layer is generated by inputting, to the activation function h1, each of the output values of the “nh” dimension when the input variables x(1) to x(8) are input to the linear mapping defined by the coefficients wF(1)jk (j=1 to nh, k=0 to 8). Here, wF(1)j0 is a bias parameter, and the input variable x(0) is defined as “1”. The output layer is generated by inputting, to the activation function h2, the output when the value of the node of the intermediate layer is input to the linear mapping defined by the coefficient wF(2)1j. However, the coefficient wF(2)10 is a bias parameter.

Next, the CPU 72 calculates a collecting rate RPM, which is a ratio collected by the GPF 36, of the PM in the exhaust discharged to the exhaust passage 34 based on the previous value of the PM deposition amount DPM acquired in the process of S10 (S16). Specifically, the collecting rate RPM is calculated by the CPU 72 in a state where map data having the previous value of the PM deposition amount DPM as an input variable and the collecting rate RPM as an output variable is stored in the ROM 74 in advance.

Next, the CPU 72 sets some variables acquired in the process of S10 as input variables of the mapping defined by the mapping data 76a stored in the storage device 76 shown in FIG. 1, the mapping outputs a PM oxidation amount OPM which is the oxidation amount of the PM by the GPF 36 (S18). That is, the CPU 72 substitutes the rotation speed NE tor the input variable x(1), substitutes the filling efficiency η to the input variable x(2), substitutes the filter temperature Tgpf to the input variable x(3), substitutes the upstream average value Afuave to the input variable x(4), and substitutes the previous value of the PM deposition amount DPM to the input variable x(5).

Next, the CPU 72 calculates the PM oxidation amount OPM by inputting the input variables x(1) to x(5) generated by the process of S18 to the mapping that outputs the PM oxidation amount OPM (S20). The mapping according to the present embodiment is configured by a neural network in which the intermediate layer is one layer, the activation function g1 of the intermediate layer is hyperbolic tangent, and the activation function g2 of the output layer is ReLU.

Here, the value of each node in the intermediate layer is generated by inputting, to the activation function g1, each of the output values of the “ng” dimension when the input variables x(1) to x(5) of the process of S18 are input to the linear mapping defined by the coefficients wS(1)jk (j=1 to ng, k=0 to 5). Here, wS(1)j0 is a bias parameter, and the input variable x(0) is defined as “1”. The output layer is generated by inputting, to the activation function g2, the output when the value of the node of the intermediate layer is input to the linear mapping defined by the coefficient wS(2)lj. The coefficient wS(2)10 is a bias parameter.

Next, the CPU 72 updates the PM deposition amount DPM by adding the value obtained by subtracting the PM oxidation amount OPM from the value obtained by multiplying the PM emission amount QPM by the collecting rate RPM to the previous value of the PM deposition amount DPM acquired by the process of S10 (S22). Then, the CPU 72 determines whether or not the PM deposition amount DPM is greater than or equal to a predetermined amount DPMthH (S24). When determining that the PM deposition amount DPM is greater than or equal to the predetermined amount DPMthH (S24: YES), the CPU 72 substitutes “1” to the regeneration flag F (S26). The initial value of the regeneration flag F is “0”.

When the process of S26 is completed or when a negative determination is given in the process of S24, the CPU 72 ends the series of processes shown in FIG. 3.

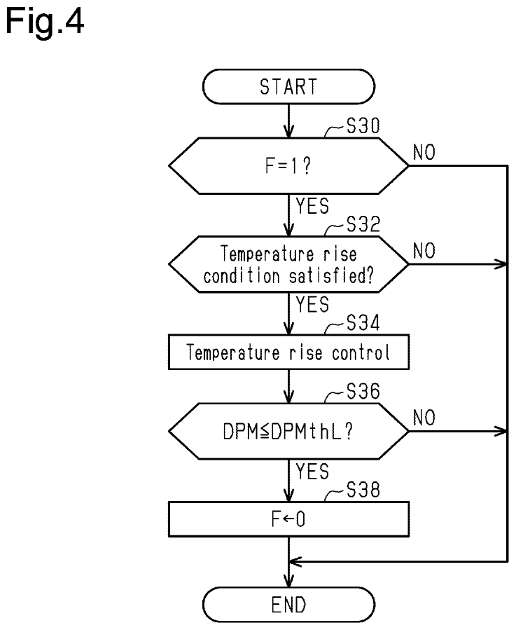

FIG. 4 shows the procedure of the regeneration process M26. The process shown in FIG. 4 is implemented by the CPU 72 repeatedly executing the handling program 74b stored in the ROM 74 shown in FIG. 1, for example, in predetermined cycles.

In the series of processes shown in FIG. 4, the CPU 72 first determines whether or not the regeneration flag F is “1” (S30). When determining that the regeneration flag F is “1” (S30: YES), the CPU 72 determines whether or not the execution condition of the temperature rise control for raising the temperature of the GPF 36 to oxidize and remove PM in the GPF 36 is satisfied (S32). Here, the temperature rise condition may be that the load region of the internal combustion engine 10 is, for example, a high load region where the original exhaust gas temperature becomes high. When determining that the execution condition of the temperature rise control is satisfied (S32: YES), the CPU 72 executes the temperature rise control for raising the temperature of the GPF 36, for example, by operating the ignition device 28 to raise the exhaust gas temperature, operating the port injection valve 16 and the in-cylinder injection valve 26 to increase the unburned fuel entering the GPF 36, and the like (S34). At least the ignition device 28, the port injection valve 16, and the in-cylinder injection valve 26 are operation units of the internal combustion engine 10 and are raising operation units for raising the filter temperature Tgpf of the GPF 36. Then, the CPU 72 determines whether or not the PM deposition amount DPM is less than or equal to a specified amount DPMthL that is smaller than the predetermined amount DPMthH (S36). When determining that the PM deposition amount DPM has become less than or equal to the specified amount DPMthL (S36: YES), the CPU 72 substitutes “0” to the regeneration flag F (S38).

When the process of S38 is completed or when a negative determination is given in the processes of S30, S32, and S36, the CPU 72 ends the series of processes shown in FIG. 4.

Next, a method for generating the mapping data 76a will be described.

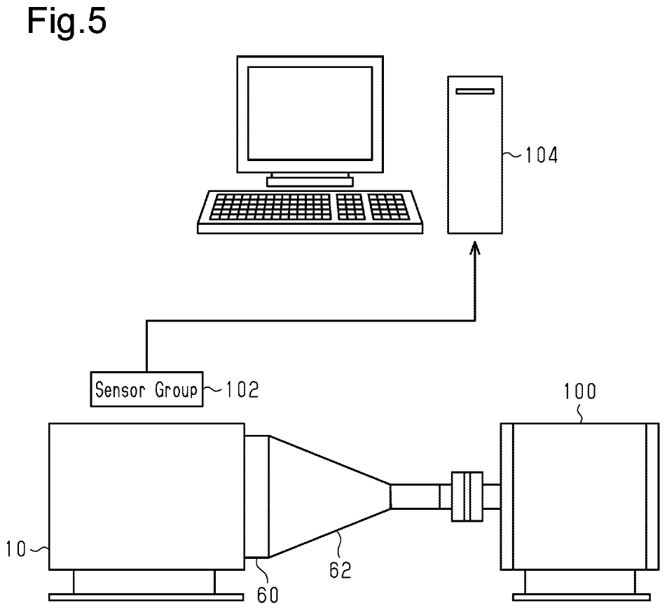

FIG. 5 shows a system for generating the mapping data 76a.

As shown in FIG. 5, in the present embodiment, a dynamometer 100 is mechanically coupled to the crankshaft 30 of the internal combustion engine 10 by a torque converter 60 and a transmission 62. Various state variables when the internal combustion engine 10 is operated are detected by the sensor group 102, and the detection results are input to an adaptation device 104, which is a computer that generates the mapping data 76a. The sensor group 102 includes an upstream air-fuel ratio sensor 86, an intake air temperature sensor 92, and the like, which are sensors that detect values for generating input to the mapping. The sensor group 102 includes a PM sensor that detects the flow rate of the PM discharged to the exhaust passage 34.

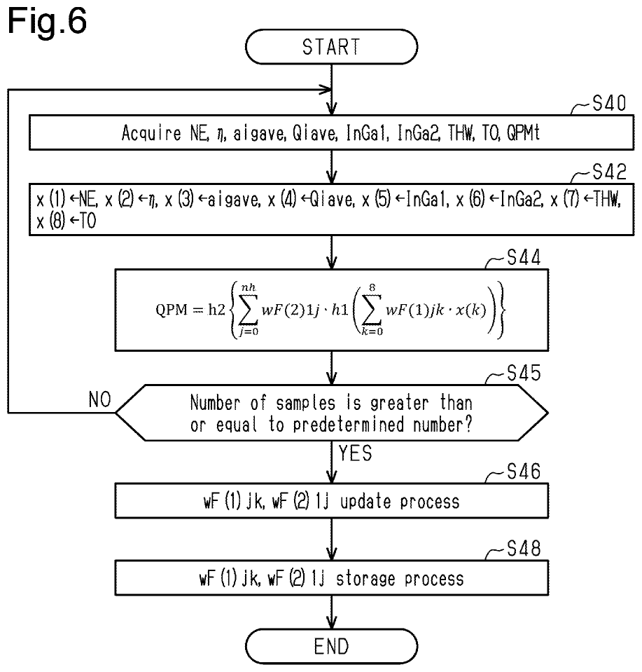

FIG. 6 shows the procedure of a mapping data generation process that defines a mapping that outputs the PM emission amount QPM. The process shown in FIG. 6 is executed by the adaptation device 104. The process shown in FIG. 6 may be implemented by, for example, providing the adaptation device 104 with a CPU and a ROM, and executing a program stored in the ROM by the CPU.

In the series of processes shown in FIG. 6, the adaptation device 104 first acquires as the training data, the same data as that used as the input variables x(1) to x(8) in the process of S12 based on the detection result of the sensor group 102. The PM emission amount QPMt detected by the PM sensor is also acquired as teacher data of the supervised learning in the training data (S40). The last letter t of QPMt represents teacher data of the supervised learning.

Next, the adaptation device 104 substitutes training data other than the teacher data of the supervised learning into the input variables x(1) to x(8) in the same manner as the process of S12 (S42). Then, the adaptation device 104 calculates the PM emission amount QPM using the input variables x(1) to x(8) obtained by the process of S42 in the same manner as the process of S14 (S44). Then, the CPU 72 determines whether or not the number of samples of the PM emission amount QPM calculated by the process of S44 is greater than or equal to a predetermined value (S45). Here, in order for the number of samples of the PM emission amount QPM to be greater than or equal to a predetermined number, the PM emission amount QPM is required to be calculated at various action points defined by the rotation speed NE and the filling efficiency η by changing the operation state of the internal combustion engine 10.

When determining that the number of samples of the PM emission amount QPM is not greater than or equal to the predetermined value (S45: NO), the adaptation device 104 returns to the process of S40. When determining that the number of samples of the PM emission amount QPM is greater than or equal to a predetermined number (S45: YES), the CPU 72 updates the coefficients wF(1)ji and wF(2)lj to minimize the sum of squares of the difference between the PM emission amount QPMt serving as the teacher data of the supervised learning and each PM emission amount QPM calculated by the process of S44 (S46). The adaptation device 104 then stores the coefficients wF(1)ji, wF(2)lj as learned mapping data 76a (S48).

When the process of S48 is completed, the adaptation device 104 ends the series of processes shown in FIG. 6.

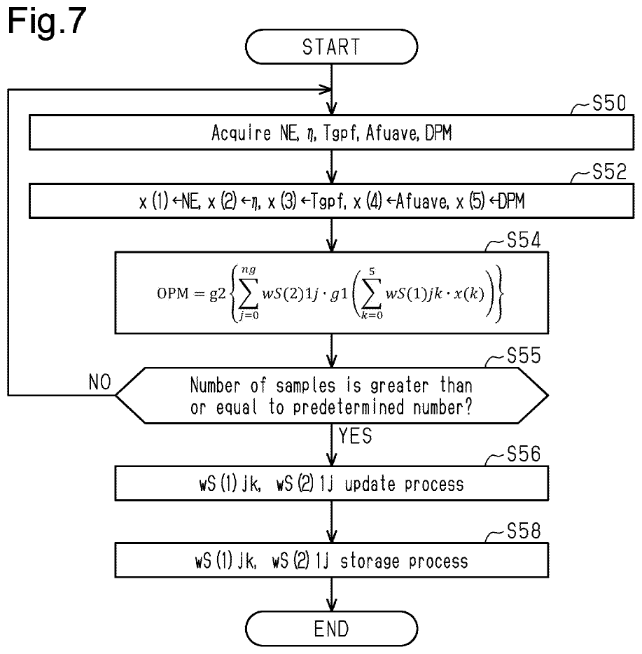

FIG. 7 shows the procedure of a mapping data generation process that defines a mapping outputting the PM oxidation amount OPM. The process shown in FIG. 7 is executed by the adaptation device 104.

In the series of processes shown in FIG. 7, the adaptation device 104 first acquires as the training data, the same data as that used as the input variables x(1) to x(5) in the process of S18 based on the detection result of the sensor group 102. The PM oxidation amount OPMt is also acquired as teacher data of the supervised learning (S50). Here, the weight of the GPF 36 is measured, and after the PM deposition amount DPM is acquired based on the weight of the GPF 36, the GPF 36 is disposed in the exhaust passage 34. The internal combustion engine 10 is operated with the action point of the internal combustion engine 10 fixed to acquire the input variables x(1) to x(4) in the process of S18 is acquired. Thereafter, the GPF 36 is removed from the exhaust passage 34, the weight of the GPF 36 is measured, and the change amount in the PM deposition amount DPM is calculated based on the difference in the weight of the GPF 36 with before the operation. Then, the PM oxidation amount OPMt is calculated based on the change amount of the PM deposition amount DPM and the value obtained by multiplying the PM emission amount QPM by the collecting rate RPM.

Next, the adaptation device 104 substitutes training data other than the teacher data of the supervised learning into the input variables x(1) to x(5) in the same manner as the process of S18 (S52). Then, the adaptation device 104 calculates the PM oxidation amount OPM using the input variables x(1) to x(5) obtained by the process of S52 in the same manner as the process of S20 (S54). Then, the CPU 72 determines whether or not the number of samples of the PM oxidation amount OPM calculated by the process of S54 is greater than or equal to a predetermined value (S55). Here, in order for the number of samples of the PM oxidation amount OPM to be greater than or equal to a predetermined value, the PM emission amount QPM is required to be calculated at various action points defined by the rotation speed NE and the filling efficiency η by changing the operation state of the internal combustion engine 10 when the PM deposition amount DPM takes each of a plurality of values.

When determining that the number of samples of the PM oxidation amount OPM is not greater than or equal to a predetermined number (S55: NO), the adaptation device 104 returns to the process of S50. When determining that the number of samples of the PM oxidation amount OPM is greater than or equal to a predetermined number (S55: YES), the CPU 72 updates the coefficients wS(1)ji and wS(2)1j to minimize the sum of squares of the difference between the PM oxidation amount OPMt serving as the teacher data of the supervised learning and each PM oxidation amount OPM calculated by the process of S54 (S56). The adaptation device 104 stores the coefficients wS(1)ji and wS(2)1j as learned mapping data 76a (S58).

When the process of S58 is completed, the adaptation device 104 ends the series of processes shown in FIG. 7.

The operation and advantages of the present embodiment will now be described.

The CPU 72 calculates the PM emission amount QPM with the rotation speed NE, the filling efficiency η, the ignition timing average value aigave, the increase amount average value Qiave, the starting integrated air amount InGa1, the post-starting integrated air amount InGa2, the coolant temperature THW, and the intake air temperature TO as inputs. Here, if the ignition timing aig is retarded, the combustion becomes unstable, and the ignition timing aig greatly affects the PM emission amount. Furthermore, since the fuel amount exceeding the stoichiometric air-fuel ratio has a tendency to cause the generation of PM, the increase amount Qi greatly affects the PM emission amount.

Furthermore, in the starting injection amount setting process M18, even if a large amount of fuel collects in the intake system such as the intake passage 12 and the intake valve 18 by injecting fuel of a large amount with respect to the fuel amount necessary for obtaining the stoichiometric air-fuel ratio, misfires are reduced. Here, compared with when the amount of fuel collected in the intake system is small, when the amount of fuel collected in the intake system is large, the generation of PM becomes noticeable as the fuel collected in the intake system flows into the combustion chamber 24. Here, the starting integrated air amount InGa1 has a positive correlation with the total amount of fuel collected in the intake system by the fuel injection when starting the internal combustion engine 10, and the post-starting integrated air amount InGa2 has a correlation with the decrease amount with respect to the large amount of fuel collected in the intake system when starting the internal combustion engine 10. That is, the starting integrated air amount InGa1 and the post-starting integrated air amount InGa2 form a collected amount variable which is a variable having a correlation with the amount of fuel collected in the intake system. When the collected amount variable is large, the PM emission amount is larger than when the collected amount variable is small.

Furthermore, the coolant temperature THW has a correlation with the temperature of the cylinder 20. When the wall surface temperature of the cylinder 20 is low, there is a tendency of fuel collecting on the wall surface and the generation of the PM is more noticeable than when the wall surface temperature is high. Moreover, since the intake air temperature TO has a correlation with the temperature of the air-fuel mixture in the compression process of the internal combustion engine 10, the intake air temperature TO has a correlation with the combustion temperature of the air-fuel mixture. As the PM emission amount varies depending on the combustion temperature, the PM emission amount varies depending on the intake air temperature TO.

Further, the rotation speed NE and the filling efficiency η are parameters that determine the flow rate of the exhaust gas and are action point variables that determine the action point of the internal combustion engine 10. The CPU 72 tends to set the operation amount of the operation unit of the internal combustion engine 10, such as the intake side valve timing variable device 44 and the EGR valve 52 according to the action point. Thus, the action point variable includes information regarding the operation amount of each operation unit and, consequently, includes information regarding the PM emission amount.

Therefore, according to the present embodiment, the PM emission amount can be calculated with high accuracy by using the input variables x(1) to x(8). Furthermore, in the present embodiment, a mapping that calculates the PM emission amount QPM by inputting various variables of the internal combustion engine 10 randomly and in large quantities is not learned by machine learning. In the present embodiment, variables to be input to the mapping are carefully selected based on the knowledge of the inventors who are familiar with the control of the internal combustion engine 10. Therefore, compared with when the inventor knowledge is not used, the number of intermediate layers of the neural network can be reduced, and the structure of the mapping for calculating the PM emission amount QPM can be simplified.

The CPU 72 calculates the PM oxidation amount OPM with the rotation speed NE, the filling efficiency η, the filter temperature Tgpf, the upstream average value Afuave, and the previous value of the PM deposition amount DPM as inputs. Here, the filter temperature Tgpf, the PM deposition amount DPM, and the oxygen amount in the fluid entering the GPF 36 have a positive correlation with the oxidation rate of the PM in the GPF 36. Furthermore, the upstream detection value Afu indicates the ratio of the amount of oxygen in the fluid entering the GPF 36 together with the rotation speed NE and the filling efficiency η. The upstream detection value Afu forms an oxygen amount variable indicating the amount of oxygen entering the GPF 36 together with a variable that particularly determines the flow rate of the exhaust gas.

Therefore, in the present embodiment, the PM oxidation amount OPM can be calculated with high accuracy by calculating the PM oxidation amount OPM based on the plurality of variables having a correlation with the PM oxidation rate. Furthermore, in the present embodiment, a mapping that calculates the PM oxidation amount OPM by inputting various variables of the internal combustion engine 10 randomly in large quantities is not learned by machine learning, and the variables input to the mapping are carefully selected based on the knowledge of the inventors who are familiar with the control of the internal combustion engine 10. Therefore, compared with when the inventor knowledge is not used, the number of intermediate layers of the neural network can be reduced, and the structure of the mapping for calculating the PM emission amount QPM can be simplified.

Furthermore, in the present embodiment, instead of calculating the change amount of the PM deposition amount DPM or the PM deposition amount DPM with a single neural network, different mappings are provided for different events. More specifically, for the deposition of PM on the GPF 36, a mapping is provided for each of the discharge of PM into the exhaust passage 34, the collection of PM on the GPF 36, and the oxidation of PM in the GPF 36. Here, for example, when calculating the change amount in the PM deposition amount DPM or the PM deposition amount DPM with a single neural network, the neural network needs to learn the effect of the input variables x on the change amount of the PM deposition amount DPM for each event. This results in a need to increase the number of intermediate layers or increase the dimension of the input variable x. In the present embodiment, the structure of each mapping can be simplified by dividing the events into discharge of PM to the exhaust passage 34, collection of PM on the GPF 36, and oxidation of PM in the GPF 36 and providing a different mapping for each event.

The present embodiment further has the advantages described below.

(1) The increase amount average value Qiave is included in the input of the mapping that outputs the PM emission amount QPM. Here, in principle, when the action point variable is included in the input of the mapping, the PM emission amount QPM can be calculated while recognizing the excess amount with respect to the fuel amount necessary for obtaining the stoichiometric air-fuel ratio without using the increase amount Qi by further using the required injection amount Qd as the input of the mapping. However, this requires the neural network to learn information on the increase amount Qi from the filling efficiency η and the required injection amount Qd. Thus, the number of intermediate layers of the neural network tends to increase. In contrast, in the present embodiment, the structure of the mapping can be simplified by including the increase amount Qi in the input of the mapping.

(2) The increase amount average value Qiave is included in the input of the mapping instead of the increase amount Qi. Thus, for example, compared to when a sampling value of a single increase amount Qi is used for each processing cycle of S10, more accurate information on the excess amount of the fuel amount with respect to the oxygen amount can be obtained without shortening the processing cycle of S10. As a result, the PM emission amount QPM can be calculated with higher accuracy.

(3) The upstream average value Afuave is included in the input of the mapping. Thus, for example, compared to when the upstream detection value Afu for each processing cycle of S10 is used, more accurate information on oxygen and unburned fuel entering the GPF 36 can be obtained without shortening the processing cycle of S10. As a result, the PM oxidation amount OPM can be calculated with higher accuracy.

### Second Embodiment

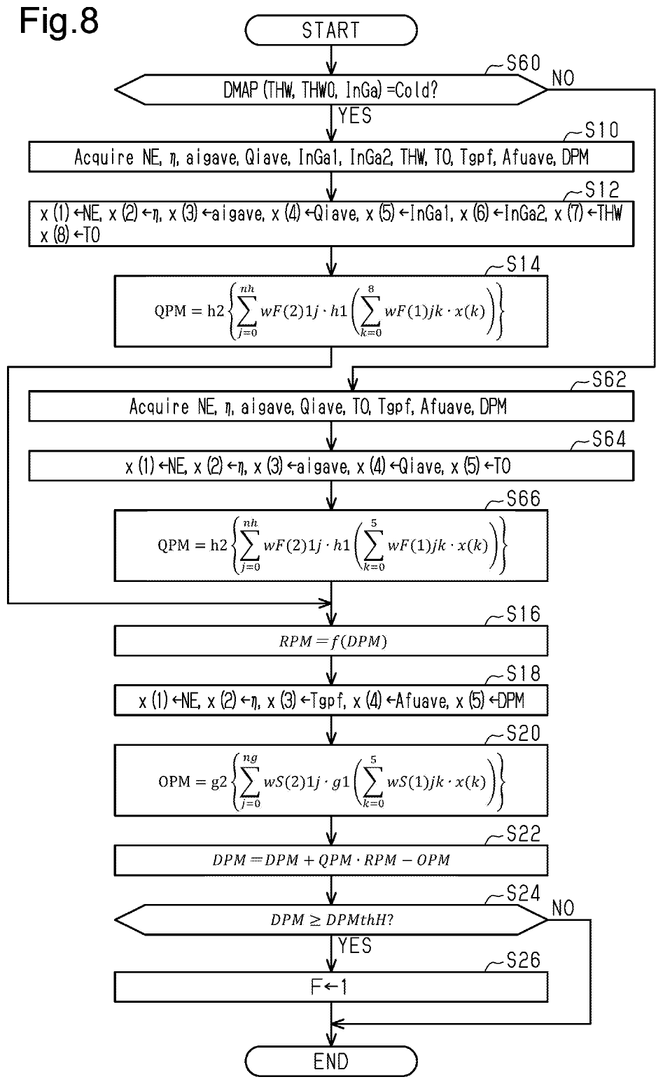

A second embodiment will now be described below with reference to FIG. 8 focusing on the differences from the first embodiment.

In the present embodiment, a different mapping that outputs the PM emission amount QPM is provided for when the internal combustion engine 10 is cold and when the internal combustion engine 10 is not cold. This allows the PM emission amount QPM to be calculated more accurately with a simple model.

FIG. 8 shows the procedure of the PM estimation process M24. The process shown in FIG. 8 is implemented by the CPU 72 repeatedly executing the PM amount estimation program 74a stored in the ROM 74 shown in FIG. 1, for example, in predetermined cycles. In FIG. 8, processes corresponding to the processes shown in FIG. 3 are denoted with the same step numbers for the sake of convenience.

In the series of processes shown in FIG. 8, the CPU 72 first determines whether or not the internal combustion engine 10 is cold based on the current coolant temperature THW, the starting coolant temperature THW0, and the integrated air amount InGa from the starting of the internal combustion engine 10 (S60). Here, the internal combustion engine 10 is cold if the PM emission amount becomes noticeable when the internal combustion engine 10 is driven at a low temperature. Specifically, the value of the output variable is map-calculated by the CPU 72 in a state in which the map data having the current coolant temperature THW, the starting coolant temperature THW0, and the integrated air amount InGa as the input variables and the value corresponding to whether or not the internal combustion engine 10 is cold as the output variable is stored in advance in the ROM 74. When determining that the internal combustion engine 10 is cold (S60: YES), the CPU 72 executes the processes of S10 to S26 of FIG. 3. The mapping data used in the process of S14 is learned only from the training data when a positive determination is given in the process of S60.

When determining that the internal combustion engine 10 is warm (S60: NO), the CPU 72 acquires the rotation speed NE, the filling efficiency the ignition timing average value aigave, the increase amount average value Qiave, the intake air temperature TO, the filter temperature Tgpf, the upstream average value Afuave, and the previous value of the PM deposition amount DPM (S62). Next, the CPU 72 uses the rotation speed NE, the filling efficiency η, the ignition timing average value aigave, the increase amount average value Qiave, and the intake air temperature TO among the variables acquired by the process of S62 as the input variables of the mapping that outputs the PM emission amount QPM (S64). That is, the CPU 72 substitutes the rotation speed NE to the input variable x(1), substitutes the filling efficiency η to the input variable x(2), substitutes the ignition timing average value aigave to the input variable x(3), substitutes the increase amount average value Qiave to the input variable x(4), and substitutes the intake air temperature TO to the input variable x(5). Then, the CPU 72 calculates the PM emission amount QPM by inputting the input variables x(1) to x(5) generated in S64 to the neural network in which the intermediate layer is one layer (S66). The activation functions h1 and h2 of the mapping are the same as those used in the process of S14, but the coefficients wF(1)jk and wF(2)ij are different from the activation functions h1 and h2 used in the process of S14. In particular, the difference is significant in wF(1)jk (j=1 to nh, k=0 to 5). In FIG. 8, the number of nodes in the intermediate layer is illustrated using the same variable “nh” as in the process of S14. However, these values are not necessarily the same. The mapping data used in the process of S66 is learned by training data in a situation where a negative determination is given in the process of S60.

When the process of S66 is completed, the CPU 72 proceeds to the process of S16.

As described above, in the present embodiment, different mappings are used for a cold period when the PM emission amount QPM is particularly noticeable and a warm period when the PM emission amount QPM is not particularly noticeable. Thus, a single mapping is not used for events in which the PM emission differs greatly. Therefore, the calculation accuracy of the PM emission amount QPM can be increased without using a complicated mapping structure that increases the number of intermediate layers. During a warm period, the effect of PM is reduced caused by the fuel collected in the intake system. Thus, the starting integrated air amount InGa1 and the post-starting integrated air amount InGa2 configuring the collected amount variable are deleted from the input of the mapping used in the process of S62. Furthermore, in a warm period, the change in the PM emission amount caused by the wall surface temperature of the cylinder 20 is small. Thus, the coolant temperature THW is deleted from the input of the mapping used in the process of S62.

### Third Embodiment

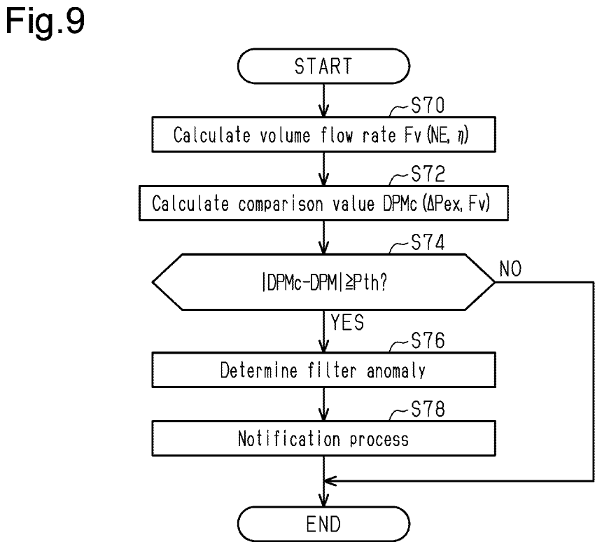

A third embodiment will now be described with reference to FIG. 9 focusing on differences from the first embodiment.

The present embodiment uses the PM deposition amount DPM to determine whether the GPF 36 has an anomaly.

FIG. 9 shows the procedure of a process related to the above determination. The process shown in FIG. 9 is implemented by the CPU 72 repeatedly executing the handling program 74b stored in the ROM 74 shown in FIG. 1, for example, in predetermined cycles.

In the series of processes shown in FIG. 9, the CPU 72 first calculates a volume flow rate Fv of the fluid in the GPF 36 based on the rotation speed NE and the filling efficiency η (S70). This can be realized, for example, by performing a map calculation of the volume flow rate Fv by the CPU 72 in a state where map data having the rotation speed NE and the filling efficiency η as input variables and the volume flow rate Fv as output variable is stored in the ROM 74 in advance.

Next, based on the pressure difference ΔPex and the volume flow rate Fv, the CPU 72 calculates a comparison amount DPMc, which is a PM deposition amount that becomes the volume flow rate Fv and the pressure difference ΔPex when the GPF 36 is functioning normally (S72). Here, the CPU 72 calculates the comparison amount DPMc to a larger value when the pressure difference ΔPex is large than when it is small. Furthermore, the CPU 72 calculates the comparison amount DPMc to a smaller value when the volume flow rate Fv is large than when it is small. This can be realized, for example, by performing a map calculation of the comparison amount DPMc with the CPU 72 in a state where map data having the volume flow rate Fv and the pressure difference ΔPex as input variables and the comparison amount DPMc as output variables is stored in the ROM 74 in advance.

Then, the CPU 72 determines whether or not the absolute value of the difference between the PM deposition amount DPM and the comparison amount DPMc is greater than or equal to a predetermined amount Pth (S74). This process is a process for determining whether or not the GPF 36 has an anomaly. That is, the comparison amount DPMc indicates the PM deposition amount that is recognized from the volume flow rate Fv and the pressure difference ΔPex when the GPF 36 does not have an anomaly. The PM deposition amount DPM is calculated based on the PM emission amount QPM or the like without depending on the pressure difference ΔPex. Therefore, if the GPF 36 does not have an anomaly, the absolute value of the difference between the PM deposition amount DPM and the comparison amount DPMc is not large.

When determining that the absolute value of the difference between the PM deposition amount DPM and the comparison amount DPMc is greater than or equal to the predetermined amount Pth (S76: YES), the CPU 72 determines that the GPF 36 has an anomaly (S76). Then, the CPU 72 performs a notification process for operating the warning lamp 98 shown in FIG. 1 to notify the user that the GPF 36 has anomaly and urge the user to replace the GPF 36 (S78).

When the process of S78 is completed or when a negative determination is given in the process of S74, the CPU 72 ends the series of processes shown in FIG. 9.

### Fourth Embodiment

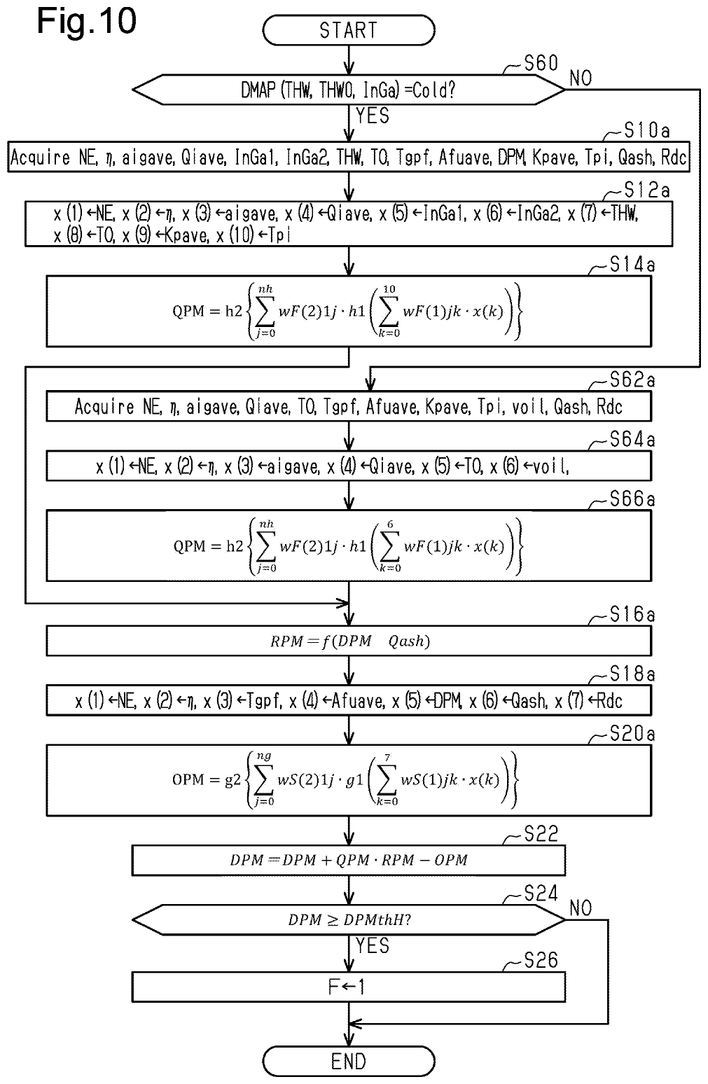

A fourth embodiment will be described below with reference to FIG. 10, focusing on the differences from the second embodiment.

In the present embodiment, the parameter used for calculation of PM deposition amount DPM is increased.

FIG. 10 shows the procedure of the PM estimation process M24. The process shown in FIG. 10 is implemented by the CPU 72 repeatedly executing the PM amount estimation program 74a stored in the ROM 74 shown in FIG. 1, for example, in predetermined cycles. In FIG. 10, processes corresponding to the processes shown in FIG. 3 are denoted with the same step numbers for the sake of convenience.

In the series of processes shown in FIG. 10, when determining that the internal combustion engine 10 is cold (S60: YES), the CPU 72 acquires the injection sharing ratio average value Kpave, the piston top face temperature Tpi, the Ash amount Qash, and the deterioration rate Rdc in addition to the variable acquired by the process of S10 in FIG. 8 (S10a). Here, the injection sharing ratio average value Kpave is an average value of the injection sharing ratio Kp in the processing cycle of FIG. 10. Furthermore, for example, the piston top face temperature Tpi is estimated to be a higher temperature by the CPU 72 when the coolant temperature THW is high than when it is low, and the piston top face temperature Tpi is estimated to be a higher temperature when the oil temperature Toil is high than when it is low. Moreover, the Ash amount Qash is the amount of Ash deposited on the GPF when the metal oxide in the lubricating oil entering the combustion chamber 24 flowed into the GPF 36 through the exhaust passage 34. The Ash has a melting point of 1000° C. or higher and is difficult to remove in the regeneration process M26. The CPU 72 calculates the Ash amount Qash by calculating the increase amount ΔQash of the Qash amount with the following equation.

ΔQash=(Traveling distance)·{(oil density)·(Ash content in oil)·(oil consumption)}

Here, the oil density and the Ash content in the oil are predetermined constants. The oil consumption is map-calculated by the CPU 72 in a state where map data having the rotation speed NE and the filling efficiency η as input variables and the oil consumption as an output variable is stored in the ROM 74 in advance.

Next, the CPU 72 generates the input variables x(1) to x(8) in the same manner as in the process of S12, substitutes the injection sharing ratio average value Kpave to the input variable x(9), and substitutes the piston top face temperature Tpi to the input variable x(10) (S12a). Then, the CPU 72 calculates the PM emission amount QPM through a neural network in which the intermediate layer is one layer with the input variables x(1) to x(10) generated in the process of S12a as the input (S14a). The activation functions h1 and h2 of the mapping are the same as those used in the process of S14, but the coefficients wF(1)jk and wF(2)ij are different. In particular, the difference is significant in wF(1)jk (j=1 to nh, k=0 to 10). The mapping data used in the process of S14a is learned by training data in a situation where a positive determination is given in the process of S60.

The injection sharing ratio average value Kpave is included in the input because the fuel combustion differs between when the fuel is injected from the port injection valve 16 and when the fuel is injected from the in-cylinder injection valve 26. This results in a difference in the PM emission amount. Furthermore, the piston top face temperature Tpi is included in the input because when the piston top face temperature Tpi is low, fuel collects on the piston 22 and causes PM.

When determining that the internal combustion engine 10 is warm (S60: NO), the CPU 72 acquires the injection sharing ratio average value Kpave, the piston top face temperature Tpi, the oil jet amount voil, the Ash amount Qash, and the deterioration rate Rdc in addition to the variables acquired in the process of S62 (S62a). Here, the oil jet amount voil is the amount of lubricating oil discharged from the oil jet 48. The oil jet amount voil may be a binary variable indicating whether the lubricant oil is discharged from the oil jet 48 or whether the discharge is stopped. However, when the discharge amount during discharging is changed by the rotation speed NE, the oil jet amount voil may be calculated as a continuous variable in correspondence with the rotation speed NE.

Next, the CPU 72 generates the input variables x(1) to x(5) in the same manner as the process of S62, and substitutes the oil jet amount voil to the input variable x(6) (S64a). Then, the CPU 72 calculates the PM emission amount QPM through the neural network in which the intermediate layer is one layer with the input variables x(1) to x(6) generated by the process of S62a as the input (S66a). The activation functions h1 and h2 of the mapping are the same as those used in the process of S64, but the coefficients wF(1)jk and wF(2)ij are different. In particular, the difference is significant in wF(1)jk (j=1 to nh, k=0 to 6). In FIG. 10, the number of nodes in the intermediate layer is described using the same variable “nh” as in the process of S14a, but these values are not necessarily the same. The mapping data used in the process of S64a is learned by training data in a situation where a negative determination is given in the process of S60.

Here, the reason the oil jet amount voil is used as the input of the mapping is because the top face temperature of the piston 22 changes in accordance with the discharge amount of the oil jet 48. In addition to the piston top face temperature Tpi, the oil jet amount voil is used as the input of mapping because in the present embodiment, it is difficult to accurately represent a transient value of the top face temperature of the piston 22 since the piston top face temperature Tpi is an estimated value in a steady state or the like.

When the processes of S14a and S66a are completed, the CPU 72 calculates the collecting rate RPM based on the PM deposition amount DPM and the Ash amount (S16a). Specifically, the CPU 72 map-calculates the collecting rate RPM in a state where map data having the PM deposition amount DPM and the Ash amount Qash as input variables and the collecting rate RPM as the output variable is stored in the ROM 74 in advance.

Next, the CPU 72 generates the input variables x(1) to x(5) in the same manner as the process of S18, substitutes the Ash amount Qash to the input variable x(6), and substitutes the deterioration rate Rdc to the input variable x(7) (S18a). Then, the CPU 72 calculates the PM oxidation amount OPM through the neural network in which the intermediate layer is one layer with the input variables x(1) to x(7) generated by the process of S18a as the input (S20a). The activation functions h1 and h2 of the mapping are the same as those used in the process of S20, but the coefficients wF(1)jk and wF(2)ij are different. In particular, the difference is significant in wF(1)jk (j=1 to nh, k=0 to 7).

Here, the Ash amount Qash is included in the input of the mapping because the oxidation rate of the PM is lower when the Ash amount Qash is large than when the Ash amount Qash is small. The deterioration rate Rdc is used as an input of the mapping because oxidation reaction is reduced when the three-way catalyst carried on the GPF 36 deteriorates.

When the process of S20a is completed, the CPU 72 proceeds to the process of S22.

### Fifth Embodiment

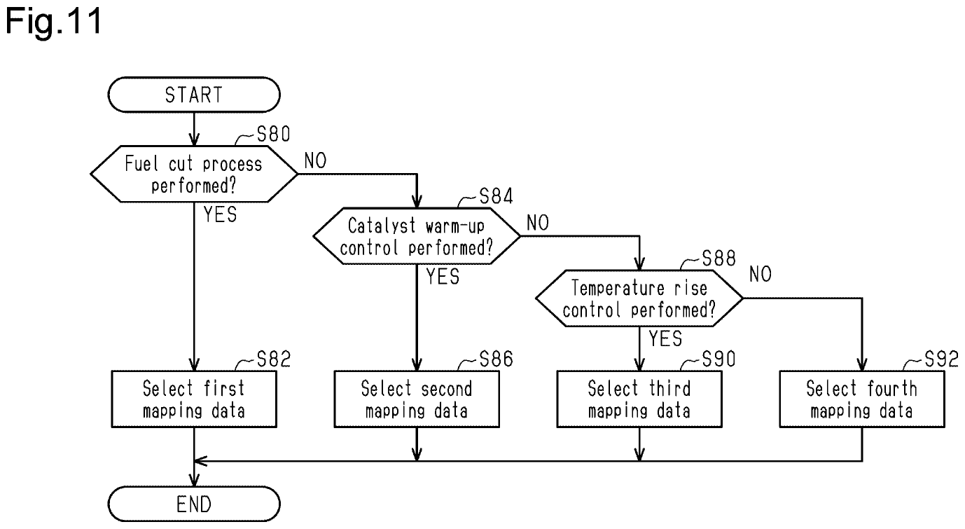

A fifth embodiment will now be described below with reference to FIG. 11, focusing on the differences from the first embodiment.

In the present embodiment, four types of mapping data are stored in the storage device 76 as the mapping data 76a.

FIG. 11 shows the procedure of a process for selecting the one of the above four types of mapping data used to calculate the PM deposition amount DPM. The process shown in FIG. 11 is implemented by the CPU 72 repeatedly executing the PM amount estimation program 74a stored in the ROM 74 shown in FIG. 1, for example, in predetermined cycles.

In the series of processes shown in FIG. 11, the CPU 72 first determines whether or not a fuel cut process is being performed (S80). Then, when determining that the fuel cut process is being performed (S80: YES), the CPU 72 selects the first mapping data (S82). The first mapping data is dedicated mapping data for execution of the fuel cut process, and is learned using the data during the fuel cut process as training data.

When determining that the fuel cut process is not being performed (S80: NO), the CPU 72 determines whether the warm-up process is being performed on the three-way catalyst or the like in the GPF 36 (S84). When determining that the catalyst is being warmed up (S84: YES), the CPU 72 selects the second mapping data (S86). The second mapping data is dedicated mapping data for catalyst warm-up, and is learned using the data during catalyst warm-up as training data.

Furthermore, when determining that catalyst warm-up is not being performed (S84: NO), the CPU 72 determines whether the temperature rise control of S34 shown in FIG. 4 (S88) is being performed. When determining that the temperature rise control is being performed (S88: YES), the CPU 72 selects the third mapping data (S90). The third mapping data is dedicated mapping data for the temperature rise control, and is learned using the data during the temperature rise control as training data.

When determining that the temperature rise control is not being performed (S88: NO), the CPU 72 selects the fourth mapping data (S92). The fourth mapping data is dedicated mapping data for when none of the fuel cut process, catalyst warm-up control, and temperature rise control is executed, and is learned using the data when none of the fuel cut process, catalyst warm-up control, and temperature rise control is executed as training data.

When the processes of S82, S86, S90, S92 are completed, the CPU 72 ends the series of processes shown in FIG. 11.

Thus, in the present embodiment, the PM deposition amount DPM is calculated using different mapping data for the fuel cut process, the catalyst warm-up control, the temperature rise control, and other times. Thus, the calculation accuracy of the PM deposition amount DPM can be improved, for example, as compared with when using the same mapping data for different situations. In the present embodiment, the structure of the mapping is as illustrated in FIG. 3. However, for example, the mapping defined by the first mapping data, the ignition timing average value aigave, the increase amount average value Qiave, the coolant temperature THW, and the intake air temperature TO may be deleted from the input.

### Sixth Embodiment

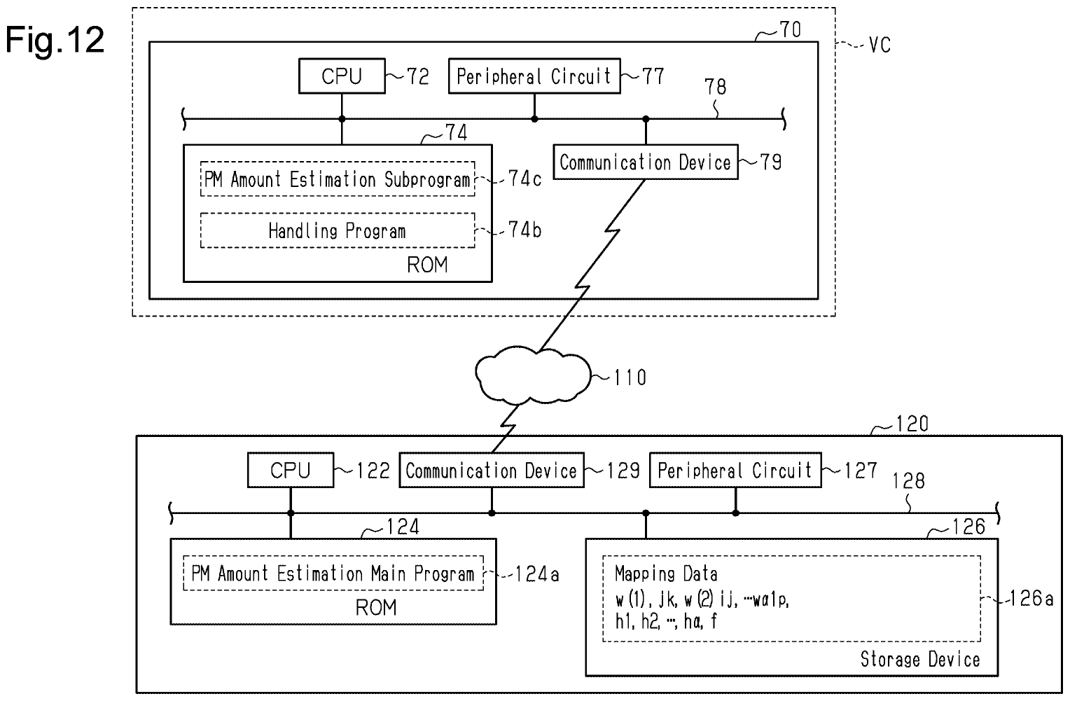

A sixth embodiment will now be described with reference to FIG. 12, focusing on the differences from the second embodiment.

In the present embodiment, the calculation process of the PM deposition amount DPM is performed outside the vehicle.

FIG. 12 shows a PM amount estimation system according to the present embodiment. In FIG. 12, members corresponding to the members shown in FIG. 1 are denoted with the same reference numerals for the sake of convenience.

The control device 70 in the vehicle VC shown in FIG. 12 includes a communication device 79. The communication device 79 is a device for communicating with a center 120 via the network 110 outside the vehicle VC.

The center 120 analyzes data transmitted from the plurality of vehicles VC. The center 120 includes a CPU 122, a ROM 124, a storage device 126, a peripheral circuit 127, and a communication device 129, which can communicate with each other through a local network 128. The ROM 124 stores the PM amount estimation main program 124a, and the storage device 126 stores the mapping data 126a.

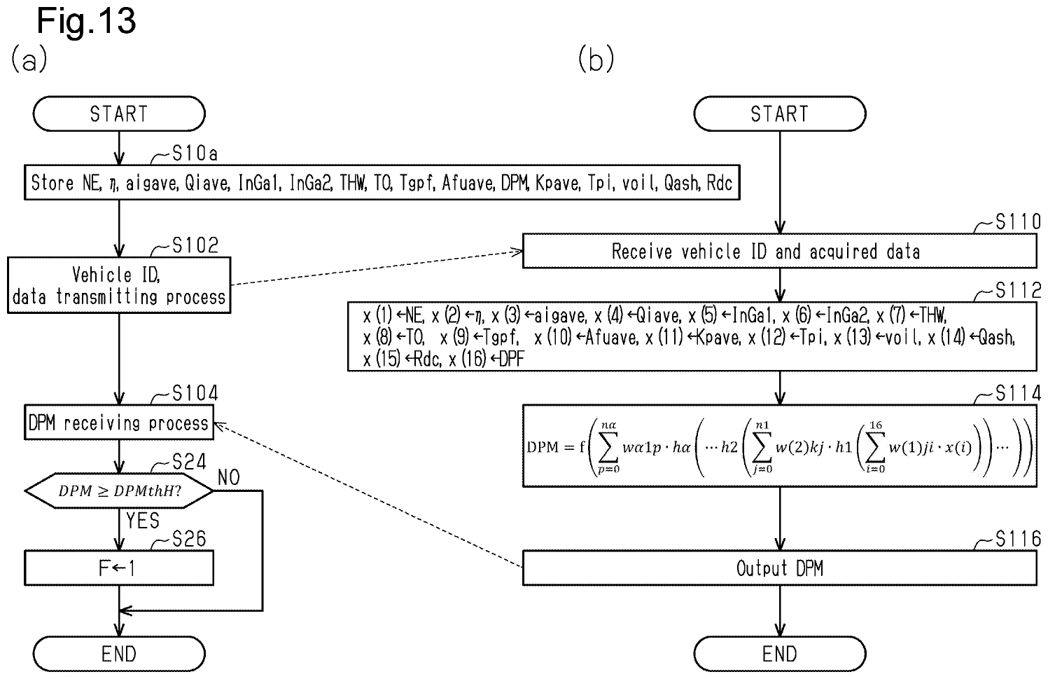

FIG. 13 includes a section (a) and a section (b) and shows procedures of a process executed by the system shown in FIG. 12. The process shown in section (a) in FIG. 13 is implemented by the CPU 72 executing the PM amount estimation subprogram 74c stored in the ROM 74 shown in FIG. 12. Furthermore, the process shown in section (b) in FIG. 13 is implemented by the CPU 122 executing the PM amount estimation main program 124a stored in the ROM 124. In FIGS. 13A and 13B, processes corresponding to the processes shown in FIG. 2 are denoted with the same step numbers for the sake of convenience. Hereinafter, the process shown in FIGS. 13A and 13B will be described in order of time with respect to the PM amount estimation process.

As shown in section (a) in FIG. 13, when the process of 10a is completed, the CPU 72 transmits the data acquired in the process of S10a together with the vehicle ID which is the identification information of the vehicle VC to the center 120 by operating the communication device 79 (S102).

The CPU 122 of the center 120 receives the transmitted data (S110) and substitutes the data acquired by the process of S110 to the input variable x of the mapping, as shown in section (b) in FIG. 13 (S112). In other words, in the same manner as the process of S12, in addition to generating the input variables x(1) to x(8), the CPU 122 substitutes the filter temperature Tgpf to the input variable x(9), substitutes the upstream average value Afuave to the input variable x(10), substitutes the injection sharing ratio average value Kpave to the input variable x(11), and substitutes the piston top face temperature Tpi to the input variable x(12). Furthermore, the CPU 122 substitutes the oil jet amount voil to the input variable x(13), substitutes the Ash amount Qash to the input variable x(14), substitutes the deterioration rate Rdc to the input variable x(15), and inputs the previous value of the PM deposition amount DPM to the input variable x(16).

Then, the CPU 122 calculates the PM deposition amount DPM by inputting the input variables x(1) to x(16) to the mapping defined by the mapping data 126a stored in the storage device 126 shown in FIG. 12 (S114).

In the present embodiment, the mapping is formed by a neural network in which the number of intermediate layers is “α”, the activation functions h1 to hα of each intermediate layer are hyperbolic tangents, and the activation function f of the output layer is ReLU. For example, the value of each node in the first intermediate layer is generated by inputting, to the activation function h1, the output when the input variables x(1) to x(16) are input to the linear mapping defined by the coefficient w(1)ji(j=0 to n1, i=0 to 16). That is, if m=1, 2, . . . , α, the value of each node of the m^{th} intermediate layer is generated by inputting, to the activation function hm, the output of the linear mapping defined by the coefficient w(m). Here, n1, n2, . . . , nα are the number of nodes in the first, second, . . . α^{th} intermediate layer. Here, w (1)j0, w(2)k0, and the like are bias parameters, and the input variable x(0) is defined as “1”.

The CPU 122 then operates the communication device 129 to transmit a signal related to a newly calculated PM deposition amount DPM to the vehicle VC that transmitted the data received by the process of S110 (S116), and ends the series of processes shown in section (b) in FIG. 13. As shown in section (a) in FIG. 13, the CPU 72 receives the PM deposition amount DPM (S104), and executes the processes of S24 to S26.

Thus, in the present embodiment, the mapping that outputs the PM deposition amount DPM is formed by a single neural network. The number of intermediate layers is more than one to easily calculate the PM deposition amount DPM with high accuracy even with a single neural network. The structure of the neural network thus becomes complicated, and the calculation load increases. However, in the present embodiment, since the PM deposition amount DPM is calculated in the center 120, the calculation load on the CPU 72 can be reduced.

Correspondence Relationship

Correspondence relationship between the matters in the embodiments described above and the matters described in the “Summary of the Invention” section is as follows. Hereinafter, the correspondence relationship is shown for every number of the example described in the section “Summary of the Invention”.

[1], [3], [11] The execution device corresponds to the CPU 72 and the ROM 74. The intake air temperature variable corresponds to the intake air temperature TO, the wall surface variable corresponds to the coolant temperature THW, and the flow rate variable corresponds to the rotation speed NE and the filling efficiency η. The acquiring process corresponds to the processes of S10, S62, 10a, and S62a.

The PM amount calculation process corresponds to the processes of S12 to S22, the processes of S64, S66, S16 to S22, the processes of Si 2a, S14a, Si 6a to S20a, S22, and the processes of S64a, S66a, S16a to S20a, S22. The operation process corresponds to the process of FIG. 4 and the process of FIG. 9.

[2] The increase variable corresponds to the increase amount average value Qiave.

[4] The ignition variable corresponds to the ignition timing average value aigave.

[5] The collected amount variable corresponds to the starting integrated air amount InGa1 and the post-starting integrated air amount InGa2.

[6] The air-fuel ratio detection variable corresponds to the upstream average value Afuave.

[7] The selecting process corresponds to the process of FIG. 11 and the process of S60.

[8] The high-temperature mapping data corresponds to the mapping data used in the processes of S66 and S66a, and the low-temperature mapping data corresponds to the mapping data used in the processes of S14 and S14a. The selecting process corresponds to the process of S60.

[9] The emission amount mapping corresponds to the mapping used in the processes of S14, S14a, S66, and S66a. The oxidation amount mapping corresponds to the mapping used in the processes of S20 and S20a. The update mapping corresponds to the mapping used in the processes of S16 and S22 and the mapping used in the processes of S16a and S22. The emission amount calculation process corresponds to the processes of S14, S14a, S66, and S66a. The oxidation amount calculation process corresponds to the processes of S20 and S20a.

[10] The high-temperature emission amount mapping data corresponds to the data used in the processes of S66 and S66a. The low-temperature emission amount mapping data corresponds to the data used in the processes of S14 and S14a.

[12] The determination process corresponds to the processes of S70 to S76. The notification process corresponds to the process of S78.

[13] The PM amount estimation system corresponds to the control device 70 and the center 120. The first execution device corresponds to the CPU 72 and the ROM 74. The second execution device corresponds to the CPU 122 and the ROM 124. The acquiring process corresponds to the process of S10a, the vehicle-side transmitting process corresponds to the process of S102, and the vehicle-side receiving process corresponds to the process of S104. The external-side receiving process corresponds to the process of S110. The PM amount calculation process corresponds to the processes of S112 and S114. The vehicle-side transmitting process corresponds to the process of S116.

[14] The data analysis device corresponds to the center 120.

[15] The control device for the internal combustion engine corresponds to the control device 70.

[16] The receiver may be formed by a portable information terminal used to execute application software for receiving information or an in-vehicle communication device. Such a receiver is hardware that forms part of the PM amount estimation system, and is configured to execute the vehicle-side receiving process S104.

### Other Embodiments

The embodiments described above may be modified and implemented as described below. The embodiments described above and the modified examples described below can be combined as long as there is technical consistency.

Regarding Wall Surface Variable

The variable related to the cylinder wall surface temperature is not limited to the coolant temperature THW. For example, the temperature of the lubricating oil of the internal combustion engine 10 may be used. Furthermore, for example, both the coolant temperature THW and the temperature of the lubricating oil may be variables related to the cylinder wall surface temperature. Moreover, for example, the wall surface temperature estimated from the coolant temperature THW or the temperature of the lubricating oil may be used.

Regarding Flow Rate Variable

The flow rate variable is not limited to the rotation speed NE and the filling efficiency η. For example, the intake air amount Ga may be the flow rate variable.

Regarding Increase Variable

The increase variable is not limited to the increase amount average value Qiave. For example, one sampling value of the increase amount Qi within the update cycle of the PM amount may be the increase variable. Furthermore, for example, the increase variable may be formed by the increase ratio obtained by dividing the increase amount Qi by the required injection amount Qd, the average value of the increase ratio, the filling efficiency η, or the base injection amount Qb. Moreover, for example, the increase variable may be formed by the required injection amount Qd and the base injection amount Qb. However, the mapping is simplified more easily when the increase variable is configured by a single variable such as the increase amount Qi or the average value of the increase amounts Qi than when the increase variable is configured by a plurality of variables.

The increase variable does not necessarily have to be included in the input of the mapping.

Regarding Action Point Variable

The action point variable is not limited to the rotation speed NE and the filling efficiency η. For example, the intake air amount Ga and the rotation speed NE may be the action point variables. Furthermore, for example, as described in the “Regarding internal combustion engine” section below, when a compression ignition type internal combustion engine is used, the injection amount and the rotation speed NE may be the action point variables. Note that it is not essential to use the action point variable as an input of the mapping. In other words, the action point variable may be one of the three sets, the set of the rotation speed NE and the filling efficiency 11, the set of the intake air amount Ga and the rotation speed NE, and the set of the injection amount and the rotation speed NE.

Regarding Collected Amount Variable

The variable indicating the amount of fuel collected in the intake system is not limited to the starting integrated air amount InGa1 and the post-starting integrated air amount InGa2. For example, the integrated value of the injection amount when starting the internal combustion engine 10 and the integrated value of the injection amount after the starting may be the collected fuel amount. Furthermore, for example, the number of injections and the coolant temperature THW when starting the internal combustion engine 10 and the elapsed time after the starting may be the collected fuel amount. Moreover, for example, the collected amount calculated as a single variable based on the starting integrated air amount InGa1 and the post-starting integrated air amount InGa2 may be the collected fuel amount. For example, as described in the “Regarding internal combustion engine” section below, when the internal combustion engine includes only the in-cylinder injection valve 26, the collected amount variable is not included in the input to the mapping. However, even when the internal combustion engine 10 includes the port injection valve 16, the collected amount variable does not necessarily have to be an input to the mapping.

Regarding Air-Fuel Ratio Detection Variable

In the embodiments described above, the upstream average value Afuave is used as the detection value of the air-fuel ratio sensor provided on the upstream side of the GPF 36, that is the estimation target of the PM deposition amount DPM. Instead, for example, the upstream detection value Afu may be used as the air-fuel ratio detection variable.

As described in the “Regarding filter” section below, when the arrangement of the GPF 36 and the catalyst 38 is exchanged, the downstream detection value Afd and the average value of the downstream detection value Afd are used as the detection value of the air-fuel ratio sensor provided on the upstream side of the GPF 36, which is the estimation subject of the PM deposition amount DPM.

The air-fuel ratio detection variable does not have to be necessarily used as an input of the mapping.

Regarding Filter Temperature

The filter temperature Tgpf is not limited to that estimated in the above process. For example, the filter temperature Tgpf may be estimated by the output value of a neural network having the rotation speed NE, the filling efficiency 11, the vehicle speed SPD, the ignition timing aig, and the like as the input. Furthermore, instead of the estimated value, for example, a temperature sensor such as a thermistor may be provided in the GPF 36 to use the detection value of the temperature sensor as the filter temperature.

The filter temperature does not necessarily have to be used. In this case, for example, a learned model for calculating the PM deposition amount DPM that reflects the PM oxidation amount OPM corresponding to the filter temperature Tgpf may be generated by having all the variables used for the estimation of the filter temperature Tgpf as inputs of mapping.

Regarding Selecting Process

In the process of FIG. 11, one of the four types of mapping data is selected through the processes of S80, S84, and S88. Instead, for example, only one of the processes of S80, S84, and S88 may be performed to select one of two types of mapping data. Further, for example, two of the processes of S80, S84, and S88 may be performed to select three types of mapping data.

Among the four types of mapping data, only the different portions between the mapping data may be the mapping that outputs the PM emission amount QPM.

In the process of FIG. 11, the process of S92 is the process of FIG. 3. Instead, for example, the process shown in FIG. 8 or the process shown in FIG. 10 may be used. The mappings selected in the processes of S80, S84, S88 and the like of FIG. 11 does not necessarily have to include the PM emission amount mapping and the PM oxidation amount mapping and, for example, may be the mapping shown in FIGS. 13A and 13B.

In place of the process of S60, the internal combustion engine 10 may be determined as being cold when the coolant temperature THW is lower than the specified temperature. This specified temperature is desirably lower than or equal to a predetermined temperature Tth.

Regarding Input of Mapping

Instead of using the injection sharing ratio average value Kpave, the injection sharing ratio Kp at a predetermined timing may be used as an input of mapping.

In the processes illustrated in FIGS. 10 and 13A and 13B, the injection sharing ratio average value Kpave, the piston top face temperature Tpi, the oil jet amount voil, the Ash amount Qash, and the deterioration rate Rdc are included in the input of the mapping. However, all of these variables do not necessarily have to be included in the input. For example, with regard to these five parameters, only four, only three, only two, or only one may be included in the input.

Furthermore, for example, the temperature at the distal end portion of the in-cylinder injection valve 26 may be included in the input of the mapping. This is because the PM emission amount changes in accordance with the temperature of the fuel injected from the in-cylinder injection valve 26 and the combustion state changes in accordance with the temperature of the distal end portion of the in-cylinder injection valve 26. However, the fuel temperature variable, which is a variable related to the temperature of the fuel, is not limited to the temperature at the distal end portion of the in-cylinder injection valve 26, and may be, for example, an estimated value or a detection value of the temperature of the fuel. When the mapping that outputs the PM emission amount QPM and the mapping that outputs the PM oxidation amount OPM are separately provided as in the processes illustrated in FIGS. 3, 8, and 10, the fuel temperature variable is desirably included in the input of the mapping that outputs the PM emission amount QPM. In this case, when a low-temperature mapping and a high-temperature mapping are used as the mapping that outputs the PM emission amount, at least the fuel temperature variable is desirably included in the input of the low-temperature mapping.

Furthermore, for example, the input of the mapping may include an external EGR variable which is a variable related to the external EGR amount, such as an EGR ratio which is a ratio of the EGR amount with respect to the sum of the air drawn into the intake passage 12 and the EGR amount entering the intake passage 12 through the EGR passage 50 and the like. Moreover, for example, an internal EGR variable which is a variable related to the internal EGR amount, such as an overlap amount of the intake valve 18 and the exhaust valve 32, and the like may be included in the input to the mapping. This is because the PM emission amount changes between, for example, a case where the EGR ratio is high and a case where the EGR ratio is low, and the fuel combustion differs depending on the EGR ratio. When the mapping that outputs the PM emission amount QPM and the mapping that outputs the PM oxidation amount OPM are separately provided as in the processes illustrated in FIGS. 3, 8, and 10, the EGR variables such as the external EGR variable and the internal EGR variable are desirably included in the input of the mapping that outputs the PM emission amount QPM. In this case, when a low-temperature mapping and a high-temperature mapping are used as the mapping that outputs the PM emission amount, at least the EGR variable is desirably included in the input of the low-temperature mapping.

The filter state variable indicating the state of the GPF 36 is not limited to the Ash amount Qash or the deterioration degree Rdc. For example, the storage amount variable which is a variable related to the oxygen storage amount in each partial region obtained by dividing the region from the upstream side to the downstream side of the GPF 36 into plurals may be a filter state variable. This is a variable that affects the temperature of the GPF 36 and the PM oxidation amount. The storage amount variable can be calculated, for example, by calculating an increase/decrease amount of the oxygen storage amount and updating the storage amount by the increase/decrease amount. The increase/decrease amount is first map-calculated for the most upstream region of the GPF 36 based on the upstream detection value Afu and the intake air amount Ga. Then, the increase/decrease amount of the oxygen storage amount in the downstream region adjacent to the most upstream region of the GPF 36 is map-calculated based on the upstream detection value Afu, the most upstream increase/decrease amount, and the intake air amount Ga. Then, the increase/decrease amount in a downstream region adjacent to the adjacent region is map-calculated based on the upstream detection value Afu, the sum of the increase/decrease amounts in the most upstream region and the adjacent region, and the intake air amount Ga. In the same manner, the increase/decrease amount in the subject region is map-calculated based on the sum of all the increase/decrease amounts in the more upstream region, the upstream detection value Afu, and the intake air amount Ga. When the mapping that outputs the PM emission amount QPM and the mapping that outputs the PM oxidation amount OPM are separately provided like in the processes illustrated in FIGS. 3, 8, and 10, the storage amount variable is desirably included in the input of the mapping that outputs the PM oxidation amount OPM.

Furthermore, for example, the atmospheric pressure may be included in the input of the mapping. For example, a variable indicating whether the fuel is heavy or light, or a fuel property variable indicating a fuel property such as the magnitude of alcohol concentration may be included in the input of the mapping. Moreover, for example, the pressure difference ΔPex may be included in the input of the mapping.

Furthermore, for example, the top face variable which is a variable related to the top face temperature of the piston 22 may be unified with the piston top face temperature Tpi by estimating the piston top face temperature Tpi based on the oil jet amount voil.

Regarding Operation Process

In the notification process of S78, the warning lamp 98 is operated as a notification device. However, the process is not limited to operating a device that outputs visual information, such as a warning lamp 98, and for example, a process for operating a device that outputs audio information may be the operation process.

For example, the notification process may be executed when the PM deposition amount DPM exceeds a threshold value larger than a predetermined amount DPMthH.

Regarding Algorithm of Machine Learning

The algorithm of machine learning is not limited to using a neural network. For example, a regression equation may be used. This corresponds to a neural network that does not including the intermediate layer.

Regarding Mapping Data

In the embodiments described above, the activation functions h1, g1 in S14, S14a, S66, S66a, S20, and S20a and the activation functions h1, h2, . . . , ha in the process of S114 are hyperbolic tangents. Furthermore, although the activation functions h2 and g2 in S14, S14a, S66, S66a, S20, and S20a and the activation function fin S114 are ReLu. Instead, for example, the activation functions h1, g1 in S14, S14a, S66, S66a, S20, and S20a, and the activation functions h1, h2, . . . , ha in the process of S114 may be ReLU. For example, the activation functions h1, g1 in S14, S14a, S66, S66a, S20, and S20a, and the activation functions h1, h2, . . . , hα in the process of S114 may be logistic sigmoid functions. Furthermore, for example, the activation functions h2 and g2 in S14, S14a, S66, S66a, S20, and S20a and the activation function fin S114 may be logistic sigmoid functions.

In FIGS. 3, 8, and 10, the mapping that outputs the PM emission amount QPM and the mapping that outputs the PM oxidation amount OPM are respectively a neural network in which the intermediate layer is one layer but instead may be, for example, a neural network in which the intermediate layer is two or more layers.

The process of S114 in section (b) in FIG. 13 includes three or more intermediate layer, but may include only one or two intermediate layers.

In the embodiments described above, the collecting rate RPM is calculated through map calculation. Instead, for example, the collecting rate RPM may be calculated with a regression equation having the Ash amount and the PM deposition amount as inputs, or a neural network in which the intermediate layer is one layer.

As an input to the neural network and the like, each dimension does not have to be configured by a single physical quantity. For example, with respect to some of the plurality of types of physical quantities using the physical quantities described above, instead of being directly input to the neural network, some main components obtained through a main component analysis may be directly input to the neural network. When the main component is an input to the neural network, part of the input to the neural network does not necessarily have to be the main component, and the entire input to the neural network may be the main component. In this case, the mapping data 76a and 126a includes data defining a mapping that determines the main component.

The mapping data is not limited to data learned through machine learning. For example, the PM emission amount mapping may be as follows. That is, first, map data having the rotation speed NE and the filling efficiency 11 as input variables and the base value of the PM emission amount QPM as an output variable is used based on the detection value of the PM emission amount QPM when the coolant temperature THW and the intake air temperature TO are fixed to a predetermined temperature and the rotation speed NE and the filling efficiency 11 are variously set. Next, map data having the coolant temperature THW, the rotation speed NE, and the filling efficiency 11 as input variables and a coolant temperature correction amount of the PM emission amount as an output variable is used from change in the detection value of the PM emission amount QPM by the change in the coolant temperature THW when the intake air temperature TO is fixed to a predetermined temperature and the rotation speed NE and the filling efficiency 11 are set. Then, map data having the intake air temperature TO, the rotation speed NE, and the filling efficiency η as input variables and an intake air temperature correction amount of the PM emission amount as an output variable is used from change in the detection value of the PM emission amount QPM by the change in the intake air temperature TO when the coolant temperature THW is fixed to a predetermined temperature and the rotation speed NE and the filling efficiency η are set. Thus, the PM emission amount QPM can be calculated by correcting the base value with the coolant temperature correction amount and the intake air temperature correction amount.

Regarding Generation of Mapping Data

For example, a sensor for detecting the PM deposition amount DPM of the GPF 36 may be provided in the sensor group 102 shown in FIG. 5, and the teacher data of the supervised learning is only the PM deposition amount DPM. Then, a mapping that outputs the PM emission amount QPM and a mapping that outputs the PM oxidation amount OPM may be learned together.

In the embodiments described above, data when the internal combustion engine 10 is operated with the dynamometer 100 connected to the crankshaft 30 is used as training data. Instead, for example, data obtained when the internal combustion engine 10 is driven in a state where the internal combustion engine 10 is mounted on the vehicle VC may be used as training data.

Regarding Determination Process

In the process of FIG. 9, the comparison amount DPMc is calculated based on the volume flow rate Fv and the pressure difference ΔPex, and the comparison amount DPMc and the PM deposition amount DPM are compared. However, as a variable indicating the flow rate of the fluid entering the GPF 36, the intake air amount Ga may be used or the sum of the intake air amount Ga and the required injection amount Qd in a predetermined period may be used in place of the volume flow rate Fv. Furthermore, instead of calculating the comparison amount DPMc, map calculation using map data having the variable indicating the flow rate, the PM deposition amount DPM, and the pressure difference ΔPex as input variables, and the value indicating whether the GPF 36 has an anomaly as an output variable may be performed. Instead of the map data, for example, a value indicating the anomaly may be calculated with a regression equation that uses the PM deposition amount DPM, the variable indicating the flow rate, and the pressure difference ΔPex as an input. Further, the regression equation outputs a value indicating whether the GPF 36 has an anomaly.

Regarding Execution Device

The execution device is not limited to a device including the CPU 72 (122) and the ROM 74 (124) and executing the software process. For example, a dedicated hardware circuit (e.g., ASIC etc.) that hardware processes at least a part of the software process executed in the above embodiment may be provided. In other words, the execution device merely needs to have any of following configurations (a) to (c). (a) A processing device that executes all of the above processes in accordance with a program, and a program storage device (including a non-transitory computer-readable storage medium) such as a ROM that stores the program. (b) A processing device and a program storage device that execute part of the above processes in accordance with a program, and a dedicated hardware circuit that performs the remaining processes. (c) A dedicated hardware circuit that executes all of the above processes. Here, there may be more than one software execution device, which includes the processing device and the program storage device, and more than one dedicated hardware circuit.

Regarding Storage Device

In the embodiment described above, the storage device storing the mapping data 76a, 126a is a storage device that differs from the storage device (ROM 74, 124) storing the PM amount estimation program 74a and the PM amount estimation main program 124a. However, there is no limit to such a configuration.

Regarding Filter

The arrangement of the GPF 36 and the catalyst 38 may be reversed. Furthermore, the filter is not limited to that supporting a three-way catalyst. For example, a three-way catalyst may be provided at the upstream side of a single catalytic converter, and a filter that does not carry the three-way catalyst may be located at the downstream side of the three-way catalyst.

Regarding Internal Combustion Engine

The internal combustion engine does not have to include both of the port injection valve 16 and the in-cylinder injection valve 26. The internal combustion engine may include one of these two types of fuel injection valves.

The internal combustion engine is not limited to a spark ignition type internal combustion engine and may be a compression ignition type internal combustion engine using, for example, diesel fuel.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A PM amount estimation device comprising:
a storage device; and
an execution device, wherein
the PM amount estimation device is applied to a filter that collects PM from exhaust gas discharged to an exhaust passage of an internal combustion engine,
the storage device is configured to store mapping data that is data defining a mapping that outputs a PM amount collected by the filter, the mapping having a flow rate variable and at least one of an intake air temperature variable and a wall surface variable as an input, the intake air temperature variable being a variable related to a temperature of air drawn into the internal combustion engine, the wall surface variable being a variable related to a cylinder wall surface temperature of the internal combustion engine, and the flow rate variable being a variable indicating a flow rate of a fluid entering the filter, and
the execution device is configured to execute:
an acquiring process for acquiring the flow rate variable and at least one of the intake air temperature variable and the wall surface variable,
a PM amount calculation process for calculating the PM amount based on the output of the mapping having the data acquired by the acquiring process as the input, and
an operation process for operating predetermined hardware in accordance with the PM amount.

2. The PM amount estimation device according to claim 1, wherein:
the input of the mapping includes an increase variable, the increase variable being a variable indicating an amount at which a fuel amount in an air-fuel mixture subject to combustion in a combustion chamber of the internal combustion engine exceeds an amount for having an air-fuel ratio of the air-fuel mixture be the stoichiometric air-fuel ratio;
the acquiring process includes a process for acquiring the increase variable; and
the PM amount calculation process is a process for calculating the PM amount based on the output of the mapping in which the increase variable is further included in the input to the mapping.

3. The PM amount estimation device according to claim 1, wherein the acquiring process includes a process for acquiring an action point variable, which is a variable defining an action point of the internal combustion engine, as the flow rate variable.

4. The PM amount estimation device according to claim 1, wherein:
the input of the mapping includes an ignition variable that is a variable related to an ignition timing;
the acquiring process includes a process for acquiring the ignition variable; and
the PM amount calculation process is a process for calculating the PM amount based on the output of the mapping in which the ignition variable is further included in the input to the mapping.

5. The PM amount estimation device according to claim 1, wherein:
the internal combustion engine includes a port injection valve;
the input to the mapping includes a collected amount variable that is a variable indicating a fuel amount collected in an intake system of the internal combustion engine;
the acquiring process includes a process for acquiring the collected amount variable; and
the PM amount calculation process is a process for calculating the PM amount based on the output of the mapping in which the collected amount variable is further included in the input to the mapping.

6. The PM amount estimation device according to claim 1, wherein:
the input of the mapping includes an air-fuel ratio detection variable that is a variable related to a detection value of an air-fuel ratio sensor located at an upstream side of the filter;
the acquiring process includes a process for acquiring the air-fuel ratio detection variable; and
the PM amount calculation process is a process for calculating the PM amount based on the output of the mapping in which the air-fuel ratio detection variable is further included in the input to the mapping.

7. The PM amount estimation device according to claim 1, wherein:
the storage device stores plural types of the mapping data; and
the PM amount calculation process includes a selecting process for selecting the mapping data used to calculate the PM amount from the plural types of mapping data.

8. The PM amount estimation device according to claim 7, wherein:
the mapping data includes high-temperature mapping data and low-temperature mapping data, the high-temperature mapping data being data defining the mapping when the temperature of the internal combustion engine is high, and the low-temperature mapping data being data defining the mapping when the temperature of the internal combustion engine is lower than the temperature of the internal combustion engine subject to the high-temperature mapping data; and
the selecting process includes a process for selecting one of the high-temperature mapping data and the low-temperature mapping data as the mapping data used to calculate the PM amount in accordance with the temperature of the internal combustion engine.

9. The PM amount estimation device according to claim 1, wherein:
the input of the mapping includes the temperature of the filter;
the acquiring process includes a process for acquiring the temperature of the filter;
the mapping includes
an emission amount mapping that outputs an emission amount of PM from the combustion chamber of the internal combustion engine to the exhaust passage having a variable other than the temperature of the filter among the variables acquired by at least the acquiring process as an input,
an oxidation amount mapping that outputs an oxidation amount of PM collected by the filter having at least the PM amount before an update and the temperature of the filter as an input, and
an update mapping that outputs the PM amount based on the PM amount before the update, the emission amount, and the oxidation amount;
the PM amount calculation process includes
an emission amount calculation process for calculating the emission amount by inputting a variable other than the temperature of the filter among the variables acquired by at least the acquiring process to the emission amount mapping,
an oxidation amount calculation process for calculating the oxidation amount by inputting at least the PM amount before the update and the temperature of the filter to the oxidation amount mapping, and
an update process for updating the PM amount by inputting the PM amount before the update, the emission amount, and the oxidation amount to the update mapping.

10. The PM amount estimation device according to claim 9, wherein:
the data defining the emission amount mapping includes high-temperature emission amount mapping data and low-temperature emission amount mapping data, the high-temperature emission amount mapping data being data defining the emission amount mapping when the temperature of the internal combustion engine is high, and the low-temperature emission amount mapping data being data defining the emission amount mapping when the temperature of the internal combustion engine is lower than the temperature of the internal combustion engine subject to the high-temperature emission amount mapping data; and
the emission amount calculation process includes a selecting process for selecting data used to calculate the emission amount from the high-temperature emission amount mapping data and the low-temperature emission amount mapping data in accordance with the temperature of the internal combustion engine.

11. The PM amount estimation device according to claim 1, wherein:
a raising operation unit is an operation unit of the internal combustion engine and used to raise the temperature of the filter; and
the operation process includes a regeneration process for combusting the PM collected by the filter by operating the raising operation unit when the PM amount is greater than or equal to a specified amount.

12. The PM amount estimation device according to claim 1, wherein the operation process includes:
a determination process for determining whether the filter has an anomaly based on a detection value of a pressure difference of an upstream side and downstream side of the filter, the flow rate of the fluid entering the filter, and the PM amount; and
a notification process for operating a notification device to issue a notification indicating that there is anomaly in the filter when determined that there is an anomaly in the determination process.

13. A PM amount estimation system comprising:
the execution device and the storage device recited in claim 1,
wherein the execution device includes a first execution device and a second execution device,
the first execution device is installed in a vehicle and configured to execute
the acquiring process,
a vehicle-side transmitting process for transmitting the data acquired by the acquiring process to outside the vehicle,
a vehicle-side receiving process for receiving a signal based on the PM amount calculated by the PM amount calculation process, and
the operation process, and
the second execution device is located outside the vehicle and configured to execute
an external-side receiving process for receiving the data transmitted by the vehicle-side transmitting process,
the PM amount calculation process, and
an external-side transmitting process for transmitting a signal based on the PM amount calculated by the PM amount calculation process to the vehicle.

14. A data analysis device comprising:
the second execution device and the storage device recited in claim 13.

15. A control device for an internal combustion engine, the control device comprising:
the first execution device recited in claim 13.

16. A receiver that is hardware configuring part of the PM amount estimation system according to claim 13, wherein the receiver is configured to execute the vehicle-side receiving process.

17. A PM amount estimating method executed by a storage device and an execution device, the PM amount estimating method being applied to a filter that collects PM from exhaust gas discharged to an exhaust passage of an internal combustion engine, the PM amount estimating method comprising:
storing mapping data that is data defining a mapping that outputs a PM amount collected by the filter with the storage device, the mapping having a flow rate variable and at least one of an intake air temperature variable and a wall surface variable as an input, the intake air temperature variable being a variable related to a temperature of air drawn into the internal combustion engine, the wall surface variable being a variable related to a cylinder wall surface temperature of the internal combustion engine, and the flow rate variable being a variable indicating a flow rate of a fluid entering the filter;
acquiring the flow rate variable and at least one of the intake air temperature variable and the wall surface variable with the execution device;
calculating the PM amount based on the output of the mapping having the acquired data as an input with the execution device; and
operating predetermined hardware in accordance with the PM amount with the execution device.
